(19) United States
(12) Patent Application Publication
(10) Pub. No.: US 2026/0311040 A1
(43) Pub. Date: Oct. 8, 2026

(54) FEDERATED LEARNING FOR MULTI-LOCATION MACHINE LEARNING MODELS

(71) Applicant: Armada Systems, Inc., San Francisco, CA (US)

(72) Inventor: Pragyana K. Mishra, Seattle, WA (US)

(73) Assignee: Armada Systems, Inc., San Francisco, CA (US)

(21) Appl. No.: 19/172,389

(22) Filed: Apr. 7, 2025

(51) Int. Cl. G06N 20/00

(52) U.S. Cl. CPC G06N 20/00

(57) ABSTRACT

Described are systems, methods, and apparatus that enable deployment and updating of multiple machine learning (“ML”) models to different edge locations so that each edge model is improved based on training/updating done at other edge locations. In addition to updating models at different edge locations, the disclosed implementations also eliminate any risk of data exposure due to transmission between edge locations and reduce the compute capacity required to update an ML model at an edge location.

### BACKGROUND

In many existing cloud computing architectures, data generated at endpoints (e.g., mobile devices, Internet of Things (“IoT”) sensors, robots, industrial automation systems, security cameras, etc., among various other edge devices and sensors) is transmitted to centralized data centers for processing. The processed results are then transmitted from the centralized data centers to the endpoints requesting the processed results. The centralized processing approach may present challenges for growing use cases, such as for real-time applications and/or artificial intelligence (“AI”) and machine learning (“ML”) workloads. For instance, centralized processing models and conventional cloud computing architectures can face constraints in the areas of latency, availability, bandwidth usage, data privacy, network security, and the capacity to process large volumes of data in a timely manner.

### BRIEF DESCRIPTION OF DRAWINGS

The detailed description is described with reference to the accompanying figures.

FIGS. 1A through 1D are a transition diagram illustrating the generation of training data and the training of an edge model, the deployment of that edge model to multiple edge locations, the updating of portions of the edge model at different edge locations, and distribution of those updates to other edge locations, in accordance with disclosed implementations.

FIG. 1E is another transition diagram illustrating the generation and distribution of trained parameter values among multiple edge locations, in accordance with disclosed implementations.

FIGS. 2A and 2B are example illustrations of an edge computing apparatus, in accordance with disclosed implementations.

FIGS. 3A and 3B are block diagrams of an example system, in accordance with disclosed implementations.

FIG. 4 is an example computing device architecture, in accordance with disclosed implementations.

FIG. 5 is a block diagram illustrating example components of a machine learning model which can be suitably trained, in accordance with disclosed implementations.

FIG. 6 is a block diagram illustrating nodes of the machine learning model discussed with respect to FIG. 5 and example illustrations of nodes with parameter values that may be changed through training of the machine learning model at different edge locations, in accordance with disclosed implementations.

FIG. 7 is an example machine learning model object class training process, in accordance with disclosed implementations.

FIG. 8 is an example machine learning model data descriptor training/update process, in accordance with disclosed implementations.

FIG. 9 is an example machine learning model training/update process, in accordance with disclosed implementations.

FIG. 10 is an example edge machine learning model update process, in accordance with disclosed implementations.

FIG. 11 is an example multi-model update process, in accordance with disclosed implementations.

FIG. 12 is another example multi-model update process, in accordance with disclosed implementations.

### DETAILED DESCRIPTION

Described are systems, methods, and apparatus that enable deployment and updating of multiple machine learning (“ML”) models to different edge locations so that each edge model is improved based on training/updating done at other edge locations. In addition to updating models at different edge locations, the disclosed implementations also eliminate any risk of data exposure due to transmission between edge locations.

As discussed further below, in some implementations, ML models may be deployed to compute and/or memory constrained environments, referred to herein as “edge locations.” The ML models at the edge locations, referred to herein as an “edge model” or “edge model,” may be periodically tuned through training of the edge model using data collected at the edge location to refine the edge model to the specific environment at the edge location. Rather than training the entire edge model, the disclosed implementations determine which parameters of the edge model are relevant to the environment and/or object classes relevant for the edge model at the edge location. During training, those parameters are set to variable while other parameters of the edge model are set to fixed, thereby reducing the compute and memory requirements needed to tune the edge model through training. Likewise, in some implementations, in addition to or instead of selected parameters based on an object class, the collected training data may be processed to determine data descriptors of the training data and determine parameters of the edge model relevant to those data descriptors.

As edge models update particular parameters through training, the changed parameter values may periodically be transmitted from the edge location and used to update other edge models. For example, the changed parameter values for parameters that are tuned through training of the edge model, may be sent from the edge location to a management system. The management system may apply the changed parameter values received from the edge location to a main ML model to produce an updated ML model, and determine if the updated ML model performs better than a current ML model maintained by the management system. Upon determination that the updated ML model performs better than the current ML model, the management system may set the updated ML model as the current ML model and deploy the now current ML model to other edge locations that include corresponding edge models. In some implementations, deployment of the current ML model to other edge models may include only transmission of changed parameter values that are different between the current ML model and the edge model. By only transmitting changed parameter values between locations, in the event the transmission is intercepted, no potentially relevant information is compromised as only parameter values are being transmitted.

A data descriptor, as used herein, is a machine-generated numerical representation that characterizes properties, attributes, and/or content of source data. The data descriptor may be generated through one or more computational processes including, but not limited to, feature extraction techniques that identify and quantify specific attributes of the source data, embedding techniques that transform the source data into a compressed numerical representation within a continuous vector space, neural network processing that generates latent representations of the source data, dimensional reduction techniques applied to raw or processed data attributes, etc. A data descriptor may be structured as a one-dimensional vector, multi-dimensional tensor, or other numerical data structure suitable for computational processing. Elements of a data descriptor encode information about the source data so that the data descriptor may be used for similarity comparisons between different pieces of data, classification or categorization of the source data, retrieval of related data items, reconstruction of properties of the original source data, etc. In implementations relating to image data, the data descriptor comprises a numerical representation that characterizes visual properties, semantic content, features, and/or other attributes of a source image, generated through computer vision techniques, neural network processing, or other computational methods.

In some implementations, prior to deploying an ML model to an edge location, a training dataset, also referred to herein as training data that is used to fine tune an ML model that will operate at an edge location, may be generated using existing models, such as large language models operating on conventional cloud-based environments. That training data may then be utilized to fine tune an ML model to produce an edge model that will operate on the edge. The edge model may be further tuned for specific data, interaction, outcome, etc., that is unique to the edge location at which the edge model is to be deployed.

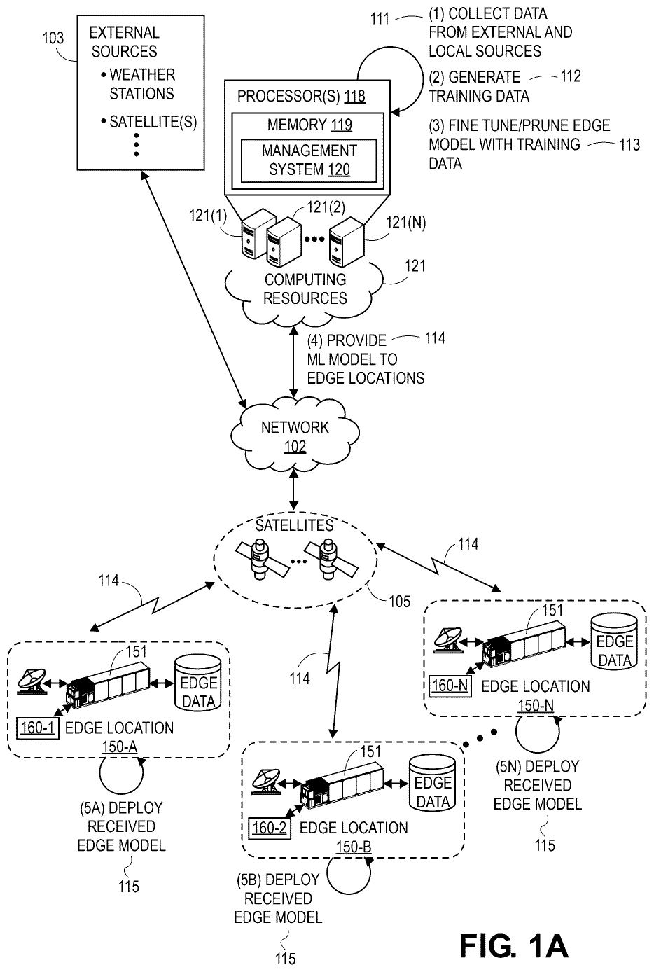

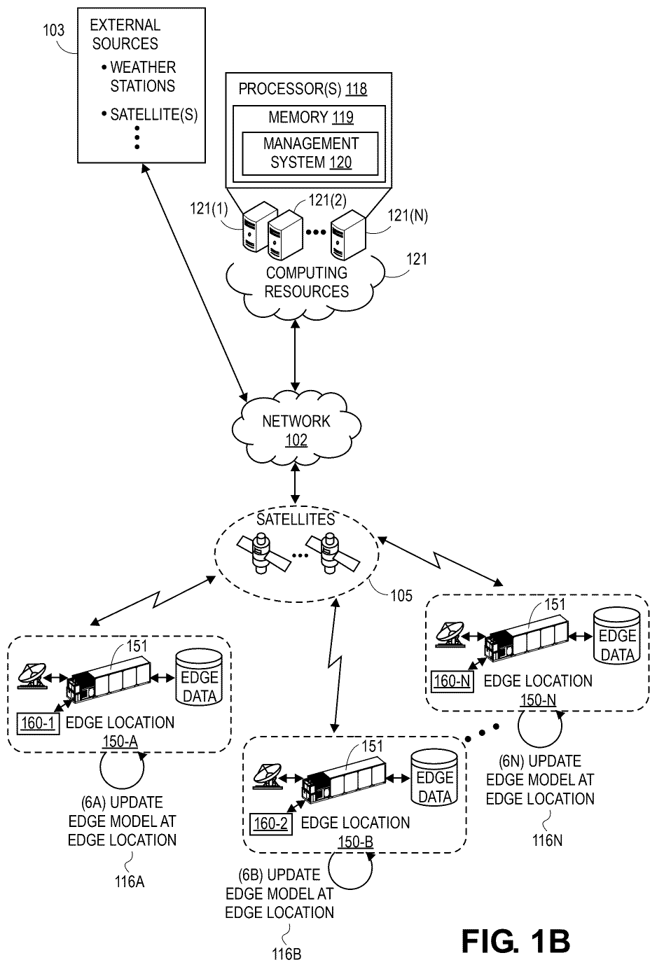

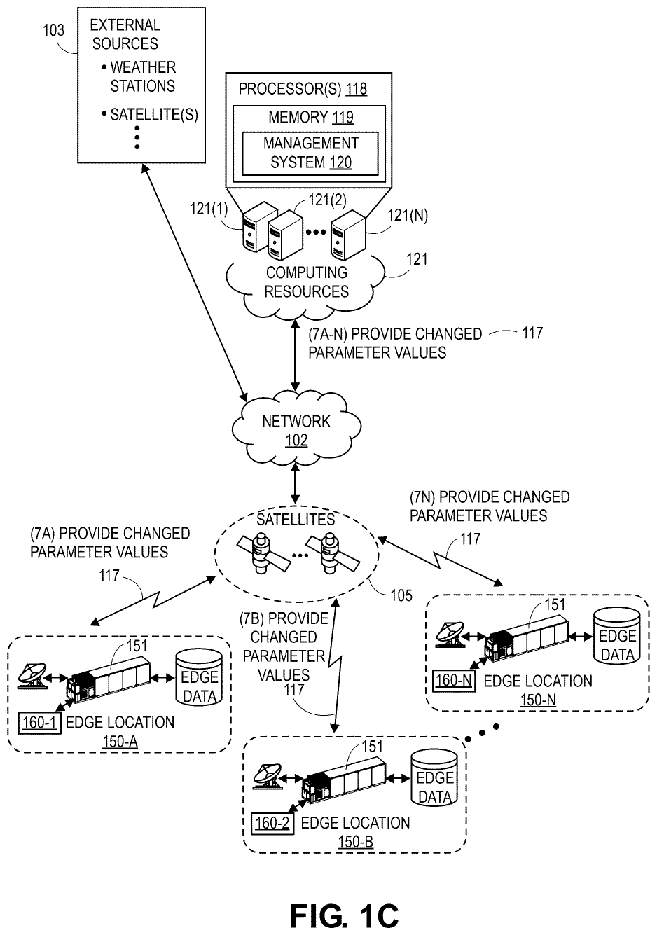

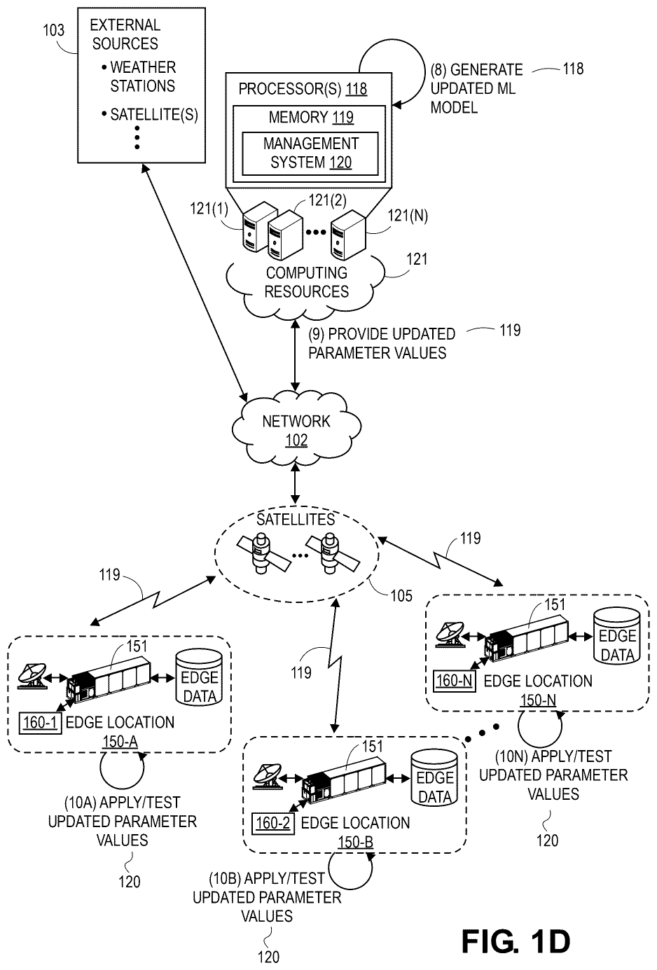

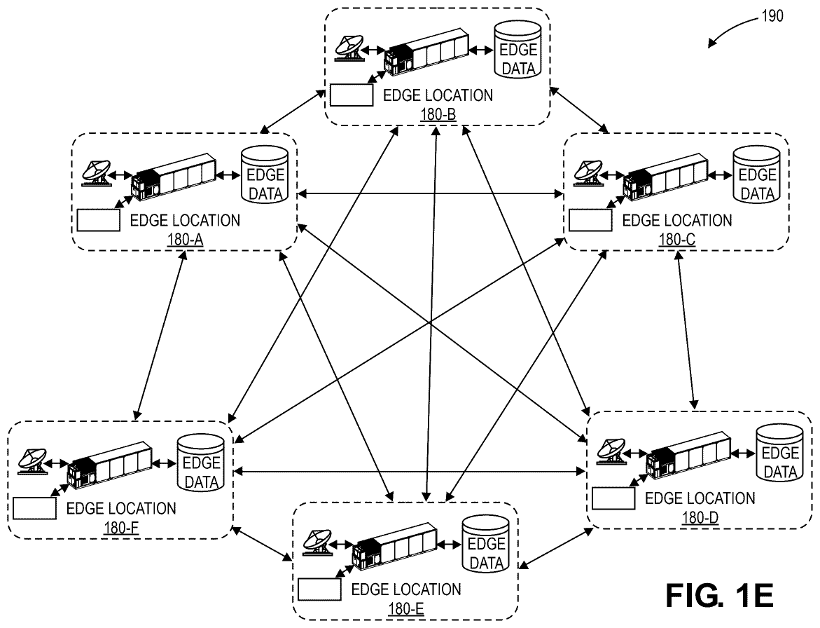

FIGS. 1A through 1D are a transition diagram illustrating the generation of training data and the training of an edge model, the deployment of that edge model to multiple edge locations, the updating of portions of the edge model at different edge locations, and the distribution of those updates to other edge locations, in accordance with disclosed implementations.

As discussed herein, one or more initial training data sets that may include one or more of image data, audio data, video data, sonar data, signal data, tabular data, statistical terms, summary statistics generated from the tabular data, natural language of the summary statistics, and/or input-output pairs (“IO pairs”) that are generated based on the tabular data and natural language of the summary statistics may be generated using one or more traditional computing resources 121 upon which a management system 120 is operating. For example, the management system 120 may access or obtain, via the network 102, time-based data, streaming data, etc., such as weather data, satellite data, video camera data, audio data, vibration sensor data, geospatial data, and/or any other form of time-based or streamed data from any of a variety of sources 103, as in 111. In addition, in some implementations, historical data from one or more edge locations where an edge model(s) is to be deployed may also be obtained and used with the disclosed implementations to generate the initial training data. Likewise, historical data from other edge locations that may or may not receive an edge model generated with the disclosed implementations may also be obtained and used. As will be appreciated, any source and/or type of existing time-based data, non-time-based data, and/or other forms of data may be utilized with the disclosed implementations to generate training data.

The computing resource(s) 121 may be remote from an edge locations 150-A, 150-B, through 150-N. Likewise, the computing resource(s) 121 may be configured to communicate over a network 102, such as the Internet with other computing resources and/or other networks, such as a satellite network 105.

As illustrated, the computing resource(s) 121 may be implemented as one or more servers 121(1), 121(2), . . . , 121(N) and may, in some instances, form a portion of a network-accessible computing platform implemented as a computing infrastructure of processors, storage, software, data access, and so forth that is maintained and accessible by components/devices of the system via a network 102, such as an intranet (e.g., local area network), the Internet, etc. The server system(s) 121 does not require end-user knowledge of the physical location and configuration of the system that delivers the services. Common expressions for these remote computing resource(s) 121 include “on-demand computing,” “software as a service (SaaS),” “platform computing,” “network-accessible platform,” “cloud services,” “data centers,” and so forth. Each of the servers 121(1)-(N) include a processor 118 and memory 119, which may store or otherwise have access to a management system 120, as described herein. The management system 120, executing on the computing resources 121 may include or access one or more ML models or artificial intelligence (“AI”) models.

For example, ML and AI models that may operate on conventional computing resources 121 and be executed or accessed by the management system 120 include, but are not limited to deep neural networks (“DNN” ), convolutional neural networks (“CNN” ), region-based CNNs (“R-CNN” ), recurrent neural networks (“RNN” ), long short-term memory (“LSTM”) networks, vision transformers (“ViT” ), multimodal transformers, variational ML models (“VAE” ), generative adversarial networks (“GAN” ), ML models, transformers, bidirectional encoder representations from transformers (“BERT”), stable diffusion, attention mechanisms, large language models (“LLM”s), etc.

The network 102, and each of the other networks discussed herein, may utilize wired technologies (e.g., wires, USB, fiber optic cable, etc.), wireless technologies (e.g., radio frequency, infrared, NFC, cellular, satellite, Bluetooth®, etc.), or other connection technologies. The network 102 is representative of any type of communication network, including data and/or voice network, and may be implemented using wired infrastructure (e.g., cable, CAT6, fiber optic cable, etc.), a wireless infrastructure (e.g., RF, cellular, microwave, satellite, Bluetooth®, etc.), and/or other connection technologies.

The collected data may then be included in the training data, as in 112. Training data may include any variety of data types. For example, training data may include image data, spatial data, non-sequential data, graph data, categorical data, text data, tabular data, etc. Likewise, to represent the variability between different data sources in real-word data, synthetic data may be generated, for example from the collected training data, that includes differences in dimensions, features, etc. Likewise, to better simulate real-world examples, elements of randomness and/or noise may be introduced into the synthetic data thereby generating a larger and more realistic distribution of data and instances of outliers.

The training data may then be used to train, fine-tune, quantize, distill, and/or prune the edge model, as in 113. As discussed herein, the edge model may be a smaller machine learning model than was used to generate the training data. For example, model(s) used to generate the training data may be larger LLMs, such as ChatGPT, GPT-4, LLaMA 2, PaLM 2®, etc., which are generally large in size, take months or years to train using massive datasets, and require large amount of compute to execute—compute amounts that are not generally available at edge locations. In comparison, the edge model may be a smaller LLM, more recently being referred to as small language models (“SLM” ) such as Q8-Chat, Chinchilla, smaller versions of LLaMA, etc., which are comparatively small in size, are faster to train, and require significantly less computing power, especially when tuned for specific data and/or edge locations.

The edge model may be trained, fine-tuned, quantized, distilled, and/or pruned by the management system 120 executing on the computing resources 121 before the edge model is deployed to an edge location, as in 113. In some implementations, the same edge model may be trained for each of the edge locations 150-A through 150-N. In other implementations, the edge model may be initially trained for all the edge locations 150-A through 150-N and then pruned for each of the different edge locations based on those edge location environments, uses of the edge model, etc. For example, if a first edge model is to be deployed to an edge location 150-A that is an offshore drilling platform and a second edge model is to be deployed to an edge location 150-B that is in the desert, those edge models may be fine-tuned and then pruned with different training data specific to those edge locations and their respective environments. For example, the first edge model may be tuned with training data relevant to offshore drilling platforms. As part of that tuning, the activation values of parameters of the first edge model may be observed. The first model may then be pruned to remove nodes/layers of the first edge model in which parameter values of those nodes/layers have little to no activation values generated during the tuning of the first edge model. Likewise, the second edge model may be tuned with training data relevant to the desert location. As part of the tuning of the second edge model, the activation values of parameters of the second edge model may be observed. Nodes and/or layers with little to no activation values may then be pruned (removed) from the second edge model. Because the two edge models are being tuned with different training data (offshore drilling v desert), some or all of the nodes/layers that are pruned may be different, thereby resulting in different edge models for the different edge locations. Pruning reduces the size, compute requirements, and overall memory footprint of the edge models.

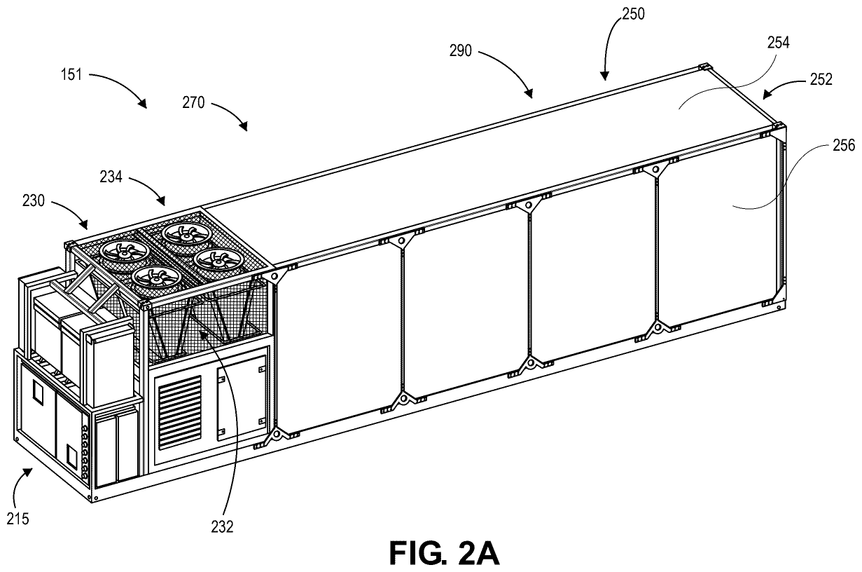

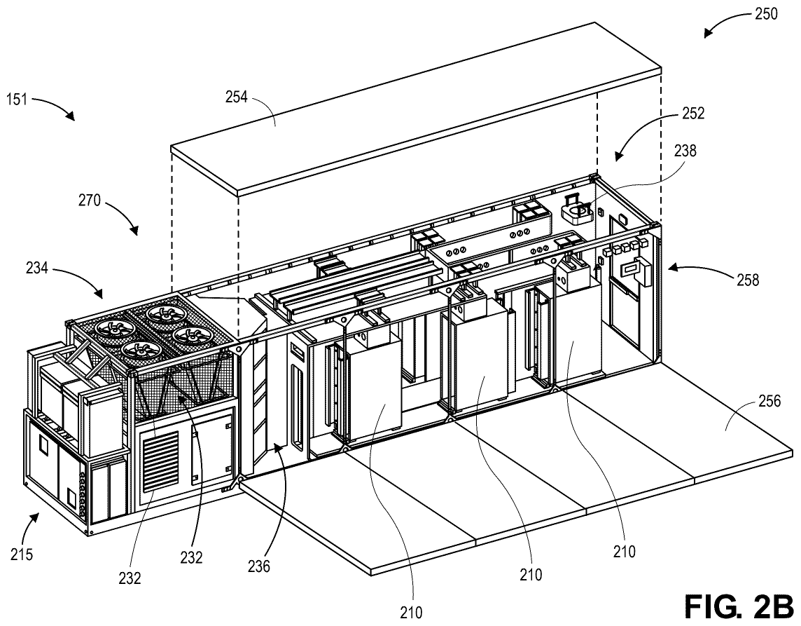

Once trained and pruned, the edge model(s) may be compressed and sent, for example via a satellite 105 transmission to one or more edge locations 150-A through 150-N, as in 114. As discussed below, the edge locations may include one or more edge computing units 151, as discussed with respect to FIGS. 2A-4. In other implementations, the edge model may be trained, loaded into memory of an edge computing unit(s) 151 and the edge computing unit(s) 151 may be physically transported, for example via helicopter, and placed at the edge location. In still another example, the edge computing unit(s) 151 may originally be connected to the computing resources 121 and receive the trained edge model before the edge computing unit is disconnected from the computing resources. Each edge location also includes an edge management system 160-A, 160-B, through 160-N. The edge management system may communicate with other edge management systems, control the updating and/or training of the edge model at the respective edge location, etc.

The edge model, once received at the edge location may be deployed for use at the edge location, as in 115. Edge models may be used for any of a variety of reasons at edge locations 150-A through 150-N. For example, edge models may be used to provide natural language insights and foresights based on data received and/or generated at the edge location, detect and identify objects in images, process image data, audio data, weather, etc. For example, the edge model may process time-series weather data, satellite data, etc., and determine why latency between the edge location and one or more satellites has changed (an insight), determine an expected window of time in the future during which data transmission is optimal (a foresight), etc. As another example, the edge model may process drill temperature data, vibration data, etc., and determine recommended drill speeds, drill depths, etc. As still another example, the edge model may process image data to detect objects represented in the image data and/or to determine predicted paths, activities, etc., of those detected objects. As will be appreciated, the disclosed implementations of an edge model deployed to an edge location may be tuned with different data and be utilized in any of a variety of scenarios, such as, but not limited to, offshore drilling, oil refineries, agriculture, autonomous vehicles, security, media and entertainment, aviation, manufacturing, warehouse automation, robotics, supply chain logistics, fulfillment, sustainability, healthcare, etc. In some implementations the data used to tune the edge model may be obtained from the edge location at which the edge model is deployed, from another data or source that is separate from but in communication with the edge location, etc.

Turning to FIG. 1B, as the edge models are executing at the edge locations 150-A through 150-N, the edge management systems 160-A through 160-N, independent of each other and independent of the management system 120, may continuously or periodically fine tune and train the respective edge models based on data received and/or generated at the location and events or actions that occur and are recorded at the edge location, as in 116-A, 116-B, through 116-N. Continuing with above example of the edge model executing at the edge location 150-B, an offshore drilling rig, the edge model may detect and identify objects (e.g., watercraft, aircraft, humans, etc.) by processing image data generated at the edge location 150-B and subsequently learn an error or difference between the object identity determined by the edge model and the actual identity of the object. Such information and knowledge may be provided back to the edge model to further refine and tune the edge model. For example, collected data and determined errors may be used as training data at the edge location to fine-tune the edge model at the edge location 150-B. As discussed further below, in some implementations, the training data at the edge location may be processed to determine an object class (e.g. watercraft, aircraft, human, etc.) of an object represented in the data and/or determine a data descriptor of the data. Utilizing that information, it may be further determined what parameters of the edge model need to be tuned to improve an accuracy of identification. In such an example, and as discussed below, those parameters of the edge model, during training, may be set to variable while other parameters of the edge model remain fixed, thereby decreasing the compute and memory required to tune the edge model at the edge location.

As illustrated in FIG. 1C, the edge management system 160-A through 160-N at each edge location sends parameter values that are changed during further training of the edge model at the edge location, referred to herein as changed parameter values, from the edge location 150-B back to the management system 120, as in 117. For example, if parameters one through ten-thousand are changed during training of the edge model at the edge location 150-B, the edge management system 160-B sends an indication of the changed parameters and the changed parameter values from the edge location 150-B back to the management system 120, for example, via the satellites 105 and/or the network 102. In other examples, the edge management system 160-B may send the indication of the changed parameters and changed parameter values from the edge location 150-B to each of the other edge management systems operating at other edge locations 150-A through 150-N, for example via the satellites 105 and/or the network 102 in addition to or instead of sending the information to the management system 120.

Similar to the edge management system 160-B tuning the edge model at the edge location 150-B, the edge management system 160-N at the edge location 150-N may also tune the edge model executing at the edge location 150-N through training based on data gathered at the edge location 150-N. For example, if the edge location is in the desert, the edge model deployed to the edge location 150-N may be tuned based on data collected at the edge location. In such an example, and even assuming the edge model at the edge location 150-N is also detecting objects in image data, the parameters that will need to be tuned for the edge model at the edge location 150-N may be very different than the parameters that were tuned for the edge model at edge location 150-B. For example, rather than detecting watercraft and aircraft, the edge model at location 150-N may be tuned to detect and identify land vehicles and aircraft. Further, the objects themselves may look very different at the different locations. As an example, even though both locations are operating to detect and identify, among other objects, aircraft, the aircraft operating in those different locations may be very different in, for example, size, shape, color, speed, etc. As such, the relevant parameters of the models at those edge locations that will be varied during tuning of the edge model may be different. For example, it may be determined that parameters five-thousand to twenty-thousand are to be set to variable while the others are fixed during tuning of the edge model at the edge location 150-N.

Similar to the edge location 150-B, the edge management system 160-N, after tuning of the edge model is complete, provides back to the management system 120 and/or to other edge management systems 160 at other edge locations an indication of the parameter values that were changed, along with the changed parameter values for those parameters. Again, in this example, while the edge management system 160-B at edge location 150-B provides changed parameter values for parameters one through ten-thousand, the edge management system 160-N at edge location 150-N provides changed parameter values for parameters five-thousand through twenty-thousand.

As discussed herein, the edge models executing at edge locations 150-A through 150-N may be continually or periodically disconnected from some or all outside sources and the edge models may rely and operate solely on data generated by sensors and/or other devices at the respective edge locations. Not only do the described implementations enable an ongoing tuning of an edge model at a remote location, with the disclosed implementations, sensitive data (e.g., company trade secrets, personnel information, edge location specific information, etc.) can be provided to and used by edge models without concern of a security breach—because the edge model may be disconnected from sources beyond the edge location and still be fully operational. Still further, because only an indication changed parameters and corresponding changed parameter values are transmitted from the edge location, for example back to the management system 120 and/or to other edge management systems 160-A through 160-N, there is no concern of security breach because no sensitive information is being transmitted-just a partial set of parameter indicators and corresponding changed parameter values.

As noted above, in some implementations, some of the parameters of the edge models that are tuned and have changed parameter values at the different edge locations may overlap. In the above example, parameter values five-thousand through ten-thousand were changed during independent tuning of the edge models at different edge locations. As discussed further below, the management system 120 and/or edge management systems 160-A through 160-N receiving the changed parameter values for the overlapping parameters may determine which set of overlapping parameter values to utilize, may determine to combine or aggregate the overlapping parameter values, etc.

As illustrated in FIG. 1D, in the illustrated example, the management system 120 may receive changed parameter values from one or more edge models operating at edge locations 150-A through 150-N and generate an updated ML model, as in 118. For example, the received changed parameter values may be applied to the current ML model maintained by the management system 120 to produce an updated ML model, and the updated ML model tested to determine if the updated ML model performs better than the current ML model. If the management system 120 determines that the updated ML model performs better than the current ML model, the management system 120 sets the updated ML model as the current ML model and provides the changed parameter values of the updated ML to each of the edge management systems 160-A through 160-N operating at the edge locations 150-A through 150-N, as in 119. In some implementations, the management system 120 may provide all the parameter values to the edge management systems 160-A through 160-N for use in updating the respective edge models. In other implementations, the management system 120 may only provide to the edge management systems 160-A through 160-N the parameter values of parameters that have changed compared to the edge model previously sent to the edge location. In still other examples, the management system 120 may provide all the changed parameter values to each of the edge locations.

Finally, the edge management systems 160-A through 160-N operating at the edge locations, upon receipt of the updated parameter values, updates the respective edge model with the updated parameter values and tests the edge model to confirm that it is performing better than the edge model performed before the updated parameter values were applied, as in 120.

FIG. 1E is another transition diagram illustrating the generation and distribution of trained parameter values among multiple edge locations, in accordance with disclosed implementations. While the example discussed with respect to FIGS. 1A through 1D illustrate a form of a hub and spoke model in which the management system 120 operating on the computing resources functions as the hub and each edge location functions as a spoke, the disclosed implementations may be realized in other configurations, such as a form of mesh network illustrated in FIG. 1E in which there is no defined hub, and/or in other configurations.

In the example illustrated in FIG. 1E, each of the edge locations 180-A, 180-B, 180-C, 180-D, 180-E, 180-F are continuously or intermittently connected, for example through wired or wireless communication channels via a network, such as the Internet, to form a mesh network 190. Accordingly, each of the edge locations 180-A through 180-F are configured to communicate with one another via the mesh network 190, either directly and/or through other edge locations. For example, the edge locations 180-A through 180-F may be configured to form a wireless mesh network that utilizes Wi-Fi®, cellular, satellite, microwave, and/or another wired or wireless means of communication, each edge location 180-A through 180-F communicating with other edge locations 180-A through 180-F.

Each of the edge locations 180-A through 180-F may form a portion of a network-accessible computing platform implemented as a computing infrastructure of processors, storage, software, data access, and other components that are maintained and accessible via a network, such as the mesh network 190 and/or another wireless or wired network (e.g., the Internet). As illustrated and discussed herein, each edge location 180-A through 180-F may include one or more edge computing units 151, edge management system, and edge data, as discussed herein.

When a message (e.g., changed parameter values) is sent to or from an edge location 180-A through 180-F, the message may include an identifier for the edge location and each edge location may act as a node within the network, forwarding the message until it is received by the intended edge location and/or each edge location 180-A through 180-F. For example, edge location 180-A may send a message, that includes changed parameter values, that is initially received by edge location 180-B. Edge location 180-B may apply the changed parameter values to an edge model maintained at edge location 180-B, determine that the applied changed parameter values result in an improved edge model, and then forward those changed parameter values to one or more of the other edge locations of the mesh network 190. Each receiving edge location will likewise process the changed parameter values and, if those changed parameter values result in an improved edge model at the edge location, will forward those changed parameter values on to one or more other edge locations. If the edge location determines that the changed parameter values, when applied to the edge model, do not result in an improved edge model, the edge location may not forward those changed parameter values. Likewise, if an edge location receives a set of changed parameter values that it has already applied or considered, it may discard those changed parameter values without forwarding those changed parameter values, thereby decreasing the load on the mesh network 190.

If there are multiple communication channels available to an edge location (e.g., cellular, satellite, etc.) and the edge location is unable to connect to other edge locations via one communication channel (or loses connection), the edge location may activate another communication channel to regain connection. For example, if an edge location cannot communicate with any other edge location via a cellular connection, the edge location may activate a satellite communication channel in an effort to achieve connectivity.

The wireless mesh network 190 may be used to provide communication between edge locations 190-A through 190-F (e.g., to share changed parameter values, weather information, etc.). In some implementations, rather than each edge location deciding whether to apply and/or forward received changed parameter values, as discussed above, one of the edge locations 180-A through 180-F may be designated or elected as the controlling edge location. In such an example, communications (e.g., changed parameter values) from any edge location may be relayed or transmitted through the mesh network 190 to the designed edge location. The designated edge location, upon receipt of the communications may process the communications and determine whether to forward those communications on to other edge locations.

For example, if edge location 180-A generates a set of changed parameter values, those changed parameter values may be transmitted through the mesh network 190 to a designated edge location, such as edge location 180-E, possibly passing through one or more other edge locations. The designated edge location, such as edge location 180-E, may then apply the changed parameter values to the edge model and determine if the changed parameter values improve the model. If the received changed parameter values improve the model, the designed edge location may then send the received changed parameter values to other edge locations within the mesh network. As will be appreciated, any of a variety of mesh network distribution schemes may be used to distribute and implement changed parameter values among edge locations of a mesh network in accordance with the disclosed implementations.

Edge computing units of the present disclosure may have any size, shape or dimensions, and may include any number of components or systems. Referring to FIGS. 2A and 2B, an edge computing apparatus 151 of the present disclosure is shown. As is shown in FIGS. 2A and 2B, the edge computing apparatus 151 comprises a plurality of server racks 210 (FIG. 2B), a plurality of power units 215, a plurality of environmental control systems 230 and an isolation system 250 disposed in a housing 270 having a form of a containerized unit 290. The edge computing apparatus 151 may be deployed to particular sites or locations, which may be referred to herein as “local sites” or “edge locations,” using one or more external propulsion units such as helicopters, road tractors, ships, trailers, trains, or others, which may be configured to lift, carry or otherwise transport the edge computing apparatus 151 to such locations, e.g., over substantially long distances. Alternatively, the edge computing apparatus 151 may further include propulsion units that are integrated with the edge computing apparatus 151, such as motors, engines, drive train components, transmissions, axles, wheels or other features. For example, in some implementations, the edge computing apparatus 151 may be an integral component of a road tractor, a trailer or a train. In some implementations, the edge computing apparatus 151 may further include one or more internal propulsion systems, e.g., electrical motors, which may be used to subsequently move or relocate the edge computing apparatus 151 for short distances upon an arrival at a local site or an edge location.

The server racks 210 may include any number of computing components, units or systems. For example, in some implementations, each of the server racks may include one or more central processing units, as well as data stores or other memory components, networking systems, power supplies, high-performance computing units, e.g., graphical processing units, field programmable gate arrays, vision processing units, associative processing units, tensor processing units, neuromorphic chips, quantum processing units, or the like. Numbers of the respective processor units or other components within each of the server racks 210 may be selected for redundancy or for resiliency, or on any other basis. Moreover, the networking systems may include one or more routers, networking switches, out-of-band switches, or systems for communication between the respective server racks 210 or any number of components of the edge computing apparatus 151 within the housing 270, or for communication with any number of external systems (not shown).

The edge computing apparatus 151 may further include one or more power units 215, which may include any number of components for generating or storing energy in any form. For example, in some implementations, the power units 215 may include any number of batteries or other power cells, e.g., dry cell or wet cell batteries such as lead-acid batteries, lithium-ion batteries, nickel cadmium batteries or nickel metal hydride batteries, or any other type, size or form of batteries. In some implementations, the power units 215 may further include one or more diesel engines, electric engines, or engines or motors that are powered by any other source of energy, e.g., gasoline, natural gas, fuel cells, nuclear reactors, solar power, or others. The power units 215 of the edge computing apparatus 151 may be selected on any basis, such as their respective peak or mean voltages, peak or mean load currents, charge times, fuel capacities, or other attributes.

In some implementations, the power units 215 may be coupled to one or more solar panel arrays that are included in, coupled to, or otherwise associated with surfaces of the edge computing unit 151. For example, solar panel arrays may be attached to a top surface of the housing 270, or in any other portion of the housing 270. The solar panel arrays may be fixed in position, or foldable, collapsible, or otherwise movable between deployed and stowed positions, and exposed in order to generate electrical power using sunlight incident upon surfaces of the solar panel arrays. Electrical power generated by solar panel arrays may be transferred to the power units 215 and used to power the edge computing unit 151 and its constituent components.

The edge computing apparatus 151 may further include one or more environmental control systems 230 in order to maintain or establish a desired set of environmental conditions (e.g., temperature, pressure, humidity, or others) within the edge computing apparatus 151. For example, the environmental control systems 230 may include, but need not be limited to, one or more air conditioning units 232, fans 234, dampers 236 and heaters 238. The air conditioning units 232 may be formed from metals, plastics or other suitable materials and include any number of compressors, condensers, evaporators or other systems for maintaining or reducing air temperatures within the edge computing apparatus 151. The environmental control systems 230 may include any number of fans 234 for initiating air flows into the air conditioning units 232 or throughout the housing 270. The environmental control systems 230 may also include one or more dampers 236 for initiating, isolating or regulating flows of air into, throughout or out of the edge computing apparatus 151. The environmental control systems 230 may further include one or more heaters 238 of any type or form, e.g., electric, gas, kerosene, propane, or others, which may include any number of systems for maintaining or increasing air temperatures within the edge computing apparatus 151.

The environmental control systems 230 shown in FIGS. 2A and 2B are integral to the edge computing apparatus 151. Alternatively, or additionally, the edge computing apparatus 151 may include any number of other environmental control systems (not shown) that operate in a standalone manner, external to the edge computing apparatus 151, in order to maintain or establish a desired set of environmental conditions within the edge computing apparatus 151.

As is shown in FIGS. 2A and 2B, the edge computing apparatus 151 may further include an isolation system 250 for isolating internal portions of the edge computing apparatus 151 from an external environment. The isolation system 250 may include a chamber 252 defined by a top cover 254, a plurality of sides 256 and a door 258.

The isolation system 250 may be configured to secure contents of the edge computing apparatus 151, e.g., the server racks 210 or others, and to protect such contents from the elements while also restricting unauthorized access or entry into the chamber 252. For example, the isolation system 250 may be closed and sealed to maintain the chamber 252 in any desired condition, e.g., at selected levels of temperature, pressure and humidity, and access to the chamber 252 may be provided by way of the door 258 following the operation of one or more access control systems, e.g., any remotely activated locking systems for such doors or other portals. Components of the isolation system 250 may have any quality, strength or security ratings. Furthermore, materials from which the cover 254, the sides 256 or the door 258 are formed or constructed may be selected to further provide radiofrequency shielding or to serve other protective functions for contents of the chamber 252.

Components of the isolation system 250 may also serve one or more other purposes, in addition to enclosing and securing portions of the edge computing apparatus 151 and contents of the chamber 252 therein. For example, portions of the isolation system 250 may also provide structural support to the housing 270 or any other portions of the edge computing apparatus 151.

The housing 270 may have any size or shape, and may take any form. In some implementations, the housing 270 may be a shipping container, or a similar vessel, of any standard shape or length. For example, in some implementations, the housing 270 may be a 40-foot vented shipping container constructed from steel and having one or more steel frames and/or castings that are sufficiently durable and strong enough to accommodate cargo, and to withstand impacts due to stacking, shocks or other contact during normal operation. In other implementations, the housing 270 may be made from a non-steel material, which may be appropriate where the containerized units 290 are deployed across wide geographical areas and need not be stacked, enabling lighter and more cost-effective materials other than steel to be used to form the housing 270. Additionally, in some implementations, the housing 270 may take the form of an intermodal container having standard dimensions including widths of approximately eight to eight-and-one-half feet (8 to 8.5 ft) and lengths of twenty, forty, forty-five, forty-eight or fifty-three feet (20, 40, 45, 48 or 53 feet) and heights of approximately eight to ten feet (8 to 10 ft), typically eight-and-one-half or nine-and-one-half feet (8.5 or 9.5 ft).

Implementations of the present disclosure may be operated, performed or executed by any type or form of computing device, apparatus or system, and need not be limited to the edge computing apparatus 151 of FIGS. 2A and 2B. Such devices, apparatuses or systems may include, but need not be limited to, cameras, mobile devices (e.g., smartphones or the like), desktop computers, laptop computers, tablet computers, wearable devices (e.g., glasses or headsets for augmented reality or virtual reality, wrist watches, or others), servers, autonomous vehicles, robotic devices, televisions that may include one or more processors, memory components or data stores, displays, sensors, input/output (or “I/O”) devices, or other systems or components that may be configured to execute one or more sets of instructions or commands described herein.

Moreover, the systems and methods described herein may be implemented in electronic hardware, computer software, firmware, or any combination thereof. For example, in some implementations, processes or methods described herein may be operated, performed or executed using computer-readable media having sets of code or instructions stored thereon. Such media may include, but need not be limited to, random-access memory (“RAM”) such as synchronous dynamic random-access memory (“SDRAM”), read-only memory (“ROM”), non-volatile random-access memory (“NVRAM”), electrically erasable programmable read-only memory (“EEPROM”), FLASH memory, magnetic or optical data storage media, or others. Alternatively, or additionally, the disclosed implementations may be realized at least in part by a computer-readable communication medium that carries or communicates program code in the form of instructions or data structures and that may be accessed, read, and/or executed by a computer. Additionally, code or instructions may be executed by one or more processors or other circuitry. For example, in some implementations, such components may include electronic circuits or hardware, programmable electronic circuits such as microprocessors, graphics processing units (“GPU”), digital signal processors (“DSP”), central processing units (“CPU”) or other suitable electronic circuits, which may be executed or implemented using computer software, firmware, or any combination thereof, to perform the various operations described herein.

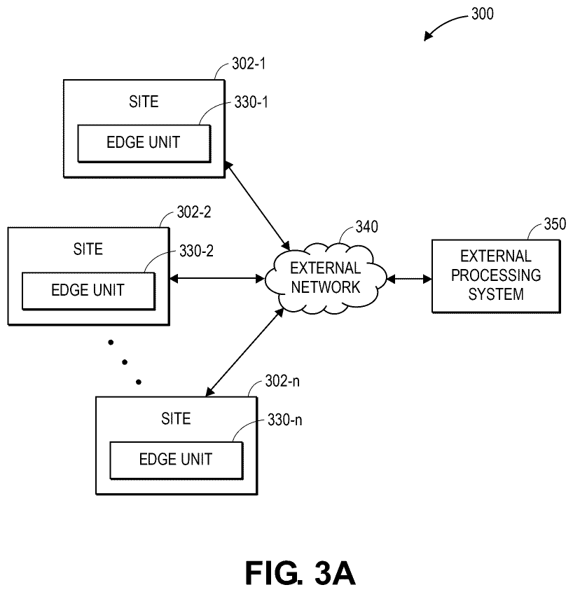

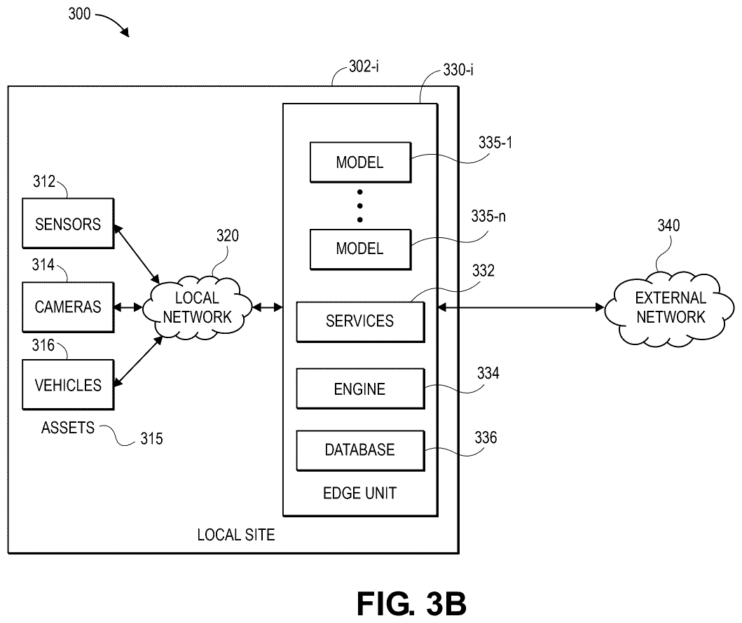

Edge computing apparatuses may be provided at any site or location and in any number, and may be connected to one another or any external systems over one or more external networks. Referring to FIGS. 3A and 3B, block diagrams of one system 300 in accordance with implementations of the present disclosure are shown.

As is shown in FIG. 3A, the edge computing system 300 includes a plurality of edge computing units (or systems) 330-1, 330-2 . . . 330-n and an external processing system 350, such as the management system 150-1 discussed above with respect to FIGS. 1A-1D. The plurality of edge computing units 330-1, 330-2 . . . 330-n are distributed at various local sites 302-1, 302-2 . . . 302-n, which may also be referred to herein as “edge locations,” and connected to one another and the external processing system 350 over an external network 340, which may include the Internet in whole or in part. Each of the sites 302-1, 302-2 . . . 302-n may include any number of edge computing units 330-1, 330-2 . . . 330-n.

As is shown in FIG. 3B, a representative one of the sites 302-1, 302-2 . . . 302-nincluding a representative one of the edge computing units 330-1, 330-2 . . . 330-n is shown. The edge computing unit 330-i may be used to implement or perform one or more aspects of the present disclosure. The edge computing unit 330-i may also be referred to as an “edge device” or an “edge compute unit.” In some implementations, the edge computing unit 330-i may be provided as a high-performance compute and storage (“HPCS”) and/or elastic-HPCS (“E-HPCS”) edge device. As is further shown in FIG. 3B, the edge computing unit 330-i may be in communication with any number of assets 315 at the site 302-i, including one or more sensors 312, one or more cameras 314, and one or more vehicles 316, or others, and may transmit information or data to such assets 315, or receive information or data from such assets 315, during operations of such assets 315 at the site 302-i, over one or more local networks 320. Such local networks 320 may include, but need not be limited to, one or more networks or other systems or techniques for communicating via any wired or wireless systems or protocols, including but not limited to cellular, Wireless Fidelity (or “Wi-Fi®”), radio frequency identification (or “RFID”), near-field communication (or “NFC”) readers, Bluetooth®, or any other type of systems or protocols.

The site 302-i may be any one of a plurality of environments or deployment locations associated with the edge computing unit 330-i. The site 302-i may be a geographic location or area associated with an enterprise user (or another user) of edge computing, or an edge location in a data network topography in terms of data network connectivity. Alternatively, or additionally, the site 302-i may be both a geographic location of an enterprise user and an edge location in the data network topography.

The edge computing unit 330-i may be configured as a containerized edge compute unit or data center for implementing sensor data generation or ingestion and inference for one or more trained machine learning or artificial intelligence models provided thereon. For instance, the edge computing unit 330-i may include computational hardware components configured to perform inference for one or more trained machine learning or artificial intelligence models. As is shown in FIG. 3B, one portion of the edge computing unit 330-i may include hardware resources associated with or used to implement a first model 335-1, while another portion of the edge computing unit 330-i may include hardware resources associated with or used to implement an n-th model 335-n, where n may be any number of different machine learning or artificial intelligence models that may be operated simultaneously or in parallel. The model or models executing by the edge computing unit 330-i may also be referred to herein as an “edge model” or “edge models.”

In some cases, the system 300 may utilize the edge computing systems 330-1, 330-2 . . . 330-n provided at one or more of the sites 302-1, 302-2 . . . 302-n to capture and process information or data received locally via the local networks 320, e.g., from any of the assets 315, and transmit the data to one or more external processing systems 350 over one or more external networks 340.

The local network 320 may provide any number of communication links between the edge computing system 330-i and respective ones of the assets 315. In some implementations, one or more aspects of the local network 320 may be implemented as a private or public “5G” network, “4G” network, “Long-Term Evolution” network, or other cellular network. Alternatively, or additionally, one or more aspects of the local network 320 may be implemented as a Wireless-Fidelity (or “Wi-Fi®”) network, a Bluetooth® network, a Zigbee® network, a Z-wave® network, a Long Range (or “LoRa®”) network, a Sigfox network, a Narrowband Internet of Things (or “NB-IoT®” network), or any other short-range wireless network.

The edge computing unit 330-i may receive different types of information or data from any number of the assets 315, and may transmit any type of information or data received from such assets 315 to any number of external processing systems 350. For example, in some implementations, the edge computing unit 330-i may receive streams of information or data from any of the sensors 312, which may include but need not be limited to one or more position sensors (e.g., Global Positioning Satellite system receivers, accelerometers, compasses, gyroscopes, altimeters), imaging devices (e.g., digital cameras, depth sensors, range cameras, infrared cameras, hyperspectral or multispectral cameras, radiographic cameras or other optical sensors), speedometers (e.g., anemometers), thermometers, barometers, hygrometers, air monitoring sensors (e.g., oxygen, ozone, hydrogen, carbon monoxide or carbon dioxide sensors), infrared sensors, ozone monitors, pH sensors, magnetic anomaly detectors, metal detectors, radiation sensors (e.g., Geiger counters, neutron detectors, alpha detectors), attitude indicators, depth gauges or sound sensors (e.g., microphones, piezoelectric sensors, vibration sensors or other transducers for detecting and recording acoustic energy from one or more directions). The sensors 312 may also include any number of memory or storage components and processors, photosensitive surfaces, filters, chips, electrodes, clocks, boards, timers or any other relevant features (not shown) for aiding in their operation.

In some implementations, the edge computing unit 330-i may also receive streams of information or data from any of the cameras 314, which may include imaging devices of any type or form, e.g., digital cameras, depth sensors or range cameras, infrared cameras, radiographic cameras or other optical sensors. The cameras 314 may be configured to photograph or otherwise capture visual information or data (e.g., still or moving images in color or black and white that may be captured at any frame rates, or depth imaging data such as ranges), or associated audio information or data, or metadata, regarding objects or activities occurring at the site 302-i, or for any other purpose.

For example, the cameras 314 may be configured to capture or detect reflected light if the reflected light is within fields of view of the cameras 314, which may be defined as a function of a distance between an imaging sensor and a lens within one of the cameras 314, viz., a focal length, as well as positions of the cameras 314 and angular orientations of their respective lenses. The cameras 314 may further include manual or automatic features for modifying a field of view or orientation. For example, one or more of the cameras 314 may be configured in a fixed position, or with a fixed focal length (e.g., fixed-focus lenses) or angular orientation. Alternatively, one or more of the cameras 314 may be configured with actuated or motorized features for adjusting a position, a focal length (e.g., zooming the imaging device) or an angular orientation (e.g., the roll angle, the pitch angle or the yaw angle), by causing a change in a distance between the imaging sensor and the lens (e.g., optical zoom lenses or digital zoom lenses), a change in a position of the cameras 314, or a change in one or more of the angles defining the angular orientation of the cameras 314.

In some implementations, one or more of the cameras 314 may be an imaging device that is hard-mounted to a support or mounting that maintains the cameras 314 in a fixed configuration or angle with respect to one, two or three axes. Alternatively, one or more of the cameras 314 may be provided with one or more motors and/or controllers for manually or automatically operating one or more of the components, or for reorienting the axis or direction of the cameras 314, i.e., by panning or tilting the cameras 314. Panning the cameras 314 may cause a rotation within a horizontal plane or about a vertical axis (e.g., a yaw), while tilting the cameras 314 may cause a rotation within a vertical plane or about a horizontal axis (e.g., a pitch). Additionally, one or more of the cameras 314 may be rolled, or rotated about its axis of rotation, and within a plane that is perpendicular to the axis of rotation and substantially parallel to a field of view of the cameras 314.

In some implementations, the edge computing unit 330-i may also receive streams of information or data from any of the vehicles 316, which may include, but need not be limited to, one or more autonomous ground vehicles, one or more autonomous aerial vehicles (e.g., drones), or any other vehicle of any type, such as cars, trucks, trailers, freight cars, container ships or aircraft, which may be manned or unmanned (e.g., drones). Such vehicles 316 may be outfitted with any number of the sensors 312 or the cameras 314 described herein.

The vehicles 316 may receive information or data of any type or form from the edge computing unit 330-i, and transmit information or data of any type or form to the edge computing unit 330-i. The vehicles 316 may also receive information or data of any type or form from the edge computing unit 330-i, and transmit information or data of any type or form to the assets 315, e.g., the sensors 312 or the cameras 314. For example, in some implementations, the edge computing unit 330-i may provide information or data regarding any number of configurations or controls to the assets 315. In some other implementations, the edge computing unit 330-i may receive onboard camera feed and other sensor information, e.g., 3D range scanner, LiDAR, or odometry information for Simultaneous Localization and Mapping (or “SLAM”), from the vehicles 316, and may transmit any number of instructions to the vehicles 316.

Additionally, in some implementations, the edge computing unit 330-i may be further utilized to execute one or more sets of instructions for locally storing information or data, executing one or more of the models 335-1 . . . 335-n, e.g., for inference, predictions or responses, or performing any other tasks or functions at the edge computing unit 330-i, with limited to no reliance on any external processing systems 350, e.g., in the “cloud.” For example, the edge computing unit 330-i may also be used to perform inference or generate predictions locally, e.g., by executing one or more of the trained or pretrained machine learning or artificial intelligence models 335-1 . . . 335-n that may be received from any external processing systems 350 or any other edge computing units.

Results or predictions generated by the models 335-1 . . . 335-n may be compressed and periodically uploaded by the edge computing unit 330-i to external processing systems 350, e.g., in the “cloud,” over the external network 340, which may include a satellite network configured to provide wireless satellite connectivity between the edge computing unit 330-i at the site 302-i and existing network infrastructure. Such results or predictions may be included in batch uploads transmitted over the external network 340, which may act as an Internet backhaul link, to any number of external processing systems 350. Additionally, in some implementations, results or predictions may be utilized immediately at the edge computing unit 330-i and transmitted in compressed form to the external processing systems 350, e.g., in the “cloud,” at a later time. For example, the external network 340 may be used to provide periodic transmission or upload of compressed prediction or inference results, e.g., during high-bandwidth or low-cost availability hours associated with the external network 340.

In some implementations, results or predictions may be obtained by performing one or more essential functions or tasks using the models 335-1 . . . 335-n, while offloading more computationally intensive and/or less time-sensitive tasks from the edge computing unit 330-i to other machine learning or artificial models executed by one or more external processing systems 350, e.g., in the “cloud.” For example, in some implementations, machine learning or artificial intelligence models operated by remote computing systems, e.g., the external processing systems 350, may be utilized to train or fine-tune one or more of the models 335-1 . . . 335-n, and updated versions of such models may be transmitted to the edge computing unit 330-i over the external networks 340, e.g., via a network backhaul. In some implementations, the models 335-1 . . . 335-n may be trained, fine-tuned, retrained or replaced in an iterative or continuous manner. For example, in some implementations, the edge computing unit 330-i may be configured to perform scheduled or periodic downloads or updates of the models 335-1 . . . 335-n based on information or data received from the external processing systems 350. Downloads or updates of the models 335-1 . . . 335-n may be distributed to the edge computing unit 330-i in a “push” fashion, whereby the external processing systems 350 transmit updated or new models to edge computing unit 330-i over the external networks 340, e.g., via a network backhaul, as updated or new models become available.

The edge computing unit 330-i may further include any number of services 332 for executing or operating with any external processing systems 350, e.g., in the “cloud,” as well as an engine 334 (e.g., a high-performance compute engine) for implementing or managing the models 335-1 . . . 335-n, and one or more databases (e.g., data stores) 336 for maintaining information or data of any type or form thereon.

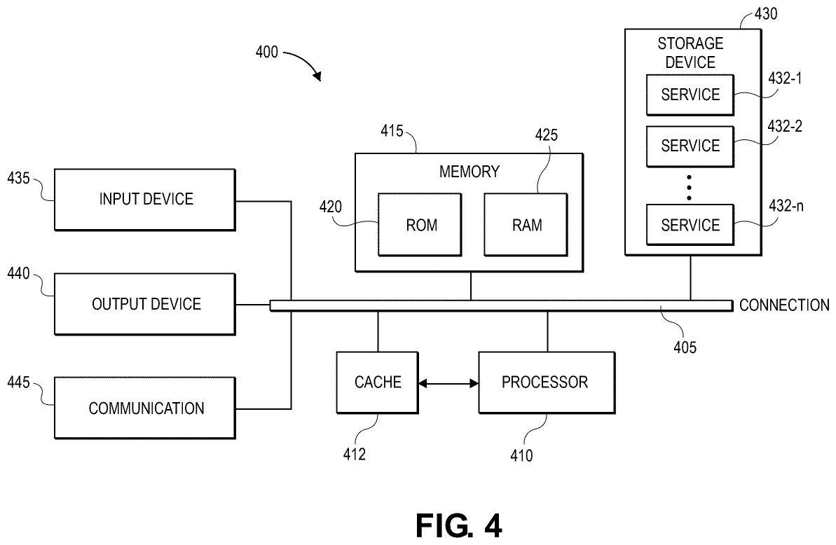

Components of computing devices or systems described herein may be arranged or configured in any number of discrete architectures. Referring to FIG. 4, a computing device architecture 400 of the present disclosure is shown. In some examples, the computing device architecture 400 may be provided on an edge computing unit, such as the edge computing apparatuses 200 of FIGS. 2A and 2B, the edge computing units 330-i, 330-1, 330-2 . . . 330-n of FIGS. 3A and 3B, or any other edge computing apparatuses or units. Alternatively, or additionally, the computing device architecture 400 may be provided on any other type or form of computing devices, such as mobile devices (e.g., smartphones or the like), desktop computers, laptop computers, tablet computers, wearable devices (e.g., glasses or headsets for augmented reality or virtual reality, wrist watches, or others), servers, autonomous vehicles, robotic devices, televisions that may include one or more processors, memory components or data stores, displays, sensors, input/output (or “I/O”) devices, or other systems or components that may be configured to execute one or more sets of instructions or commands described herein.

As is shown in FIG. 4, components of the computing device architecture 400 may be in electrical communication with each other by way of a connection 405, e.g., a bus. The computing device architecture 400 shown in FIG. 4 includes a processor unit 410 (e.g., a CPU, a GPU, or another processor unit) coupled to various components of the computing device architecture 400, including but not limited to a set of memory components 415, e.g., a cache of high-speed memory connected directly with, in close proximity to, or integrated as part of processor 410, such as read-only memory (“ROM”) 420 and random-access memory (“RAM”) 425. The processor unit 410 may be any general-purpose processor or a special-purpose processor, such as a self-contained system.

The computing device architecture 400 also includes a storage device 430 including one or more sets of data or instructions for performing various services 432-1, 432-2 . . . 432-n. The storage device 430 may be a non-volatile memory, a hard disk or another type of computer-readable media that may store data that is accessible to the computing device architecture 400 or other computers, such as magnetic cassettes, flash memory cards, solid state memory devices, digital versatile disks, cartridges, as well as the memory 415, e.g., the ROM 420, the RAM 425, and any others. One or more of the services 432-1, 432-2 . . . 432-n may be provided and executed for controlling the processor unit 410 or any other aspect of the computing device architecture 400.

The computing device architecture 400 further includes an input device 435, an output device 440 and a communications interface 445. The input device 435 enables interaction with the computing device architecture 400 and may represent any number of input mechanisms, e.g., a microphone for receiving sounds or speech signals, a touch-sensitive screen for receiving gestures or other manual inputs, or others. The output device 435 may represent any number of output mechanisms, e.g., a display, a projector, a television, a speaker device, or others. The communications interface 445 may be configured to govern or manage inputs received from users via the input device 435 and outputs to be provided to such users via the output device 440.

As used herein, the terms “device,” “system” or “unit” need not be limited to any one or a specific number of physical objects (such as one smartphone, one controller, one processing system and so on), and may instead refer to any system having any number of parts that may implement any portions of the present disclosure. Likewise, the terms “device,” “system” or “unit” are not limited to any configuration, type, or number of objects.

Devices implementing processes and methods according to these disclosures may include hardware, software, firmware, middleware, microcode, hardware description languages, or any combinations thereof, and may take any of a variety of form factors. When implemented in software, firmware, middleware, or microcode, the program code or code segments to perform the necessary tasks (e.g., a computer-program product) may be stored in a computer-readable or machine-readable medium.

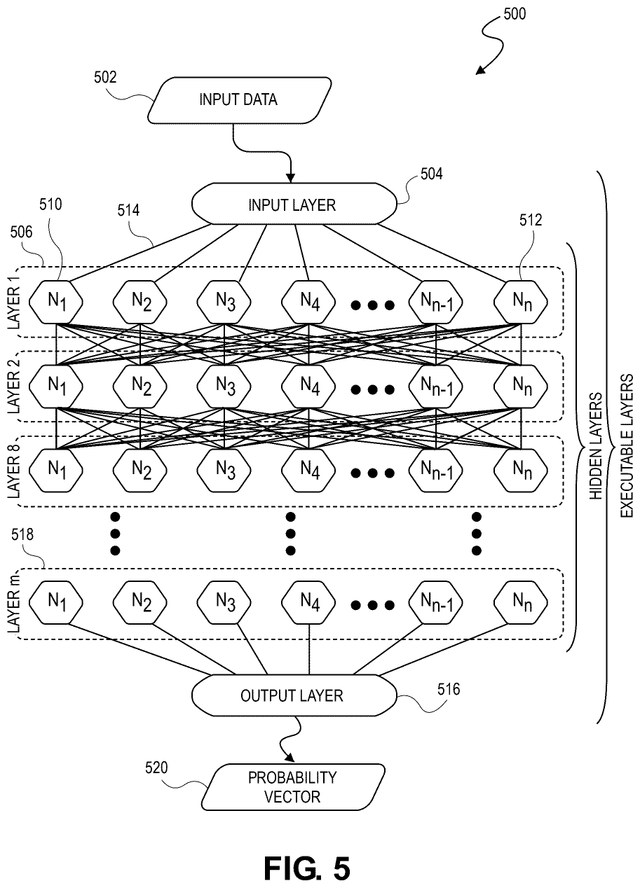

FIG. 5 is a block diagram illustrating exemplary components of a machine learning model 500 which can be suitably trained, in accordance with aspects of the disclosed implementations. For purposes of illustration, we will discuss the machine learning model 500 being trained to classify an input image into one of a plurality of object classes. It will be appreciated that training may extend well beyond image classification and the discussion is provided as exemplary and not limiting.

As those skilled in the art will appreciate, a machine learning model 500 comprises multiple executable layers, including an input layer 504, an output layer 516, and one or more hidden layers. By way of illustration, the exemplary machine learning model 500 includes m hidden layers, including hidden layers 506 and 518. The input layer 504 accepts the input data 502, such as an image, audio, text, etc., for which the machine learning model 500 is to classify the data sample into one of a plurality of classes.

The input layer 504 accepts the input data and, according to one or more predetermined algorithms and/or heuristics embedded within the various layers, maps the input through a series of process layers, each layer outputting values. These values, not shown in FIG. 5 but implied by the various edges, such as edge 514, extending from the input layer 504 to the various processing nodes of the first hidden layer 506, constitute at least some of the output of the input layer and are distributed as input data or input values to processing nodes of the first hidden layer 506 of the machine learning model 500, such as processing nodes 510 and 512.

Typically, though not exclusively, the one or more values or facets of the input data sample passed from the input layer 504 to a first processing node in the first hidden layer, such as processing node 510 of hidden layer 506, is different than a value/facet passed to a second processing node of that same hidden layer, such as to processing node 512 of hidden layer 506.

Each hidden layer, including hidden layers 506 and 518, comprises a plurality of processing or nodes. By way of illustration and not limitation, hidden layer 506 includes n processing nodes, N₁-Nₙ. While the processing nodes of the first hidden layer 506 typically, though not exclusively, have a single input value from the input layer 504, processing nodes of subsequent hidden layers typically have input values from one or more processing nodes of the previous input layer. Of course, in various implementations, the processing nodes of the first hidden layer 506 may receive, as input values, all output values of the input layer 504.

In various implementations and as illustrated in the executable machine learning model 500, each hidden layer (except for the first hidden layer 506) accepts input data/signals from each processing node of the prior hidden layer, as indicated by the edges proceeding from a processing node of an “upper” hidden layer (e.g., layer 506) to a “lower” hidden layer. Of course, alternative implementations need not include such wide distribution of output values to the processing nodes of a subsequent, lower level.

Each processing node implements one or more operations, such as convolutions, computations or transformations on the input data it receives (whether the processing node receives a single-item of input data, or plural items of input data) to produce a single output value. These operations may include any number of functions, etc. to generate the output data such as, by way of illustration and not limitation, data aggregations, clustering various input values, transformations of input values, combinations of plural input values, selections and/or filters among input values, mathematical manipulations of one or more input values, linear and/or multivariate regressions of the input values, statistical determinations of the input values, predictive evaluations, and the like. As discussed, during training of the ML model, parameter values of parameters of the operations may be adjusted to improve the accuracy of the ML model. For example, if the operation of a node is a convolution operation, the parameters include the filter/kernel of the convolution that determines what features the operation detects and the parameter values are the actual number values of those parameters. Moreover, individual items of input data may be weighted with a weighting parameter in any given processing node such that the weighted input data plays a greater or lesser role in the overall computation for that processing node. Items of input data may be weighted in such a manner as to be ignored in the various convolutions and computations. Hyperparameters (data/values that are input from sources external to processing nodes of a prior input level) may also be utilized by all or some of the processing nodes of a hidden layer.

As will be appreciated by those skilled in the art, one of the interesting aspects of training machine learning models is that the various executable levels are adaptable to accommodate self-learning. In other words, when provided feedback, modifications are made to the weights, parameters, and processing or operations of the nodes in the various layers, in order to achieve better results. Due to this adaptability, except for initially established computations of the various processing nodes in a training phase of the machine learning process, a person is unlikely to have specific insight or knowledge as to the exact nature of output values and, correspondingly, the exact nature of convolutions and/or computations that any particular processing node of a hidden layer may utilize. Instead, during the training process of a machine learning model, the machine learning model adaptively makes its own determinations as to how to modify each parameter of the operation(s) of a given processing node to produce better and/or superior results from the input values it receives. As discussed herein, these determinations may be guided by adjustments to the training data samples and/or the loss function used during training of the machine learning model.

To determine which nodes include parameters that are changed, an activation monitor, which may be included in a management system that is training the ML model, may be utilized to observe the nodes and detect changes to parameter values. While activation monitors are typically used during training to monitor activation values and/to determine from observed parameters vanishing or exploding gradients, dead nodes, parameter saturation, unhealthy parameter distributions, etc., as discussed further below, in accordance with the disclosed implementations, the observed parameter values are utilized to determine which parameters and/or nodes of the ML model are used by the ML model to process different object classes of data and/or to process data with different data descriptors.

At the final hidden layer, e.g., layer 518, the processing nodes provide their output data to the output layer 516. The output layer 516 performs whatever final aggregations, calculations, transformations, projections, normalizations and/or interpretations of the various items of input data to produce a probability vector 520 that includes a probability score for each of a plurality of classes indicating a probability that the input data sample corresponds to the class.

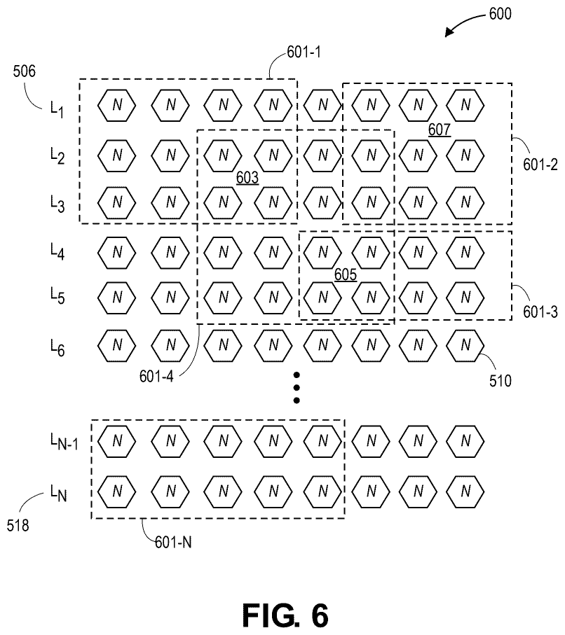

FIG. 6 is a block diagram 600 illustrating nodes 510 of the machine learning model discussed with respect to FIG. 5 and example illustrations of node sets 601-1, 601-2, 601-3, 601-4, through 601-N with parameter values that may be changed through training of the machine learning model at different edge locations, in accordance with disclosed implementations.

As discussed further below, during training, for example by the management system 120 and/or edge management system 160-A through 160-N, collectively referred to herein as “management systems,” the management system provides the ML model it is training with training data assigned to an object class (e.g., human, dog, aircraft, watercraft, land vehicle, etc.). As the model trains on training data of the object class, the management system 120/160 observes parameters of nodes 510 to determine which parameters are changed by the model during training. In some implementations, the management system 120/160 may determine parameter values for parameters of nodes prior to training the model with the object class and then compare the observed parameter values for those parameters after training to determine which parameters of which nodes have changed.

As changed parameters and/or nodes with changed parameters are determined, the management system 120/160 associates those nodes with the object class. For example and referring to FIG. 6, during training of an ML model, the management system 120/160 determines that the nodes 510 included in a first node set 601-1 are used by the ML model when identifying a first object class, that the nodes 510 included in a second node set 601-2 are used by the ML model when identifying a second object class, that the nodes 510 included in a third node set 601-3 are used by the ML model when identifying a third object class, that the nodes 510 included in a fourth node set 601-4 are used by the ML model when identifying a fourth object class, and that the nodes 510 included in an Nth node set 601-N are used by the ML model when identifying a second object class.

As illustrated, during training of the edge model with different object classes, the edge management system 120/160 may determine different node sets that include nodes with parameter values that are changed by the ML model when training on that object class. In some implementations, nodes may be included in more than one node set. For example, nodes 603 are included in both the first node set 601-1 and the fourth node set 601-4, nodes 605 are included in both the third node set 601-3 and the fourth node set 601-4, and nodes 607 are included in both the second node set 601-2 and the fourth node set 601-4. In comparison, some nodes sets may not overlap with other node sets. For example, node set 601-N includes nodes 510 that are not included in any other node set.

In some implementations, as an alternative to training the model based on object classes of objects, or in addition thereto, the ML model may be trained by data descriptors. In examples in which the ML model is being on both object class and data descriptors, the training data of an object class may be further processed to segment the training data into data descriptor groups. For example, if the training data is image data, the image data may be processed to determine features in the image data and the image data grouped based on similarities between the features of the different image data. As the ML model is trained, in addition to determining node sets of nodes that the ML model uses to identify the object class, the management system 120/160 may also determine node sets of nodes that are used by the ML model when identifying objects that have similar data descriptors (e.g., features).

In some examples, an object class may include or relate to multiple different data descriptors. As management system 120/160 trains the ML model, it may be determined that there is one node set of nodes that are relevant to determining the object class but there are four different node sets of nodes that are relevant to determining data descriptors associated with the object class. In some examples, the node sets determined for data descriptors of an object class may be encompassed by or within, at least partially, the node set determined for the object class. In other implementations, some or all of the node sets determined for data descriptors of an object class may include nodes that are not included in the node set for the object class.

While the example illustrated with respect to FIG. 6 indicates node sets including nodes that are adjacent to one another in the same layer and/or in adjacent layers, such illustration is for ease of explanation only. It will be appreciated that a determined node set may include any nodes at any position or layer within an ML model, whether those nodes are directly or indirectly connected, in the same or different layers, etc. Generally, any node of an ML model for which it is determined parameter values are changed during training on a particular object class and/or data descriptor may be included in a node set for that object class and/or data descriptor.

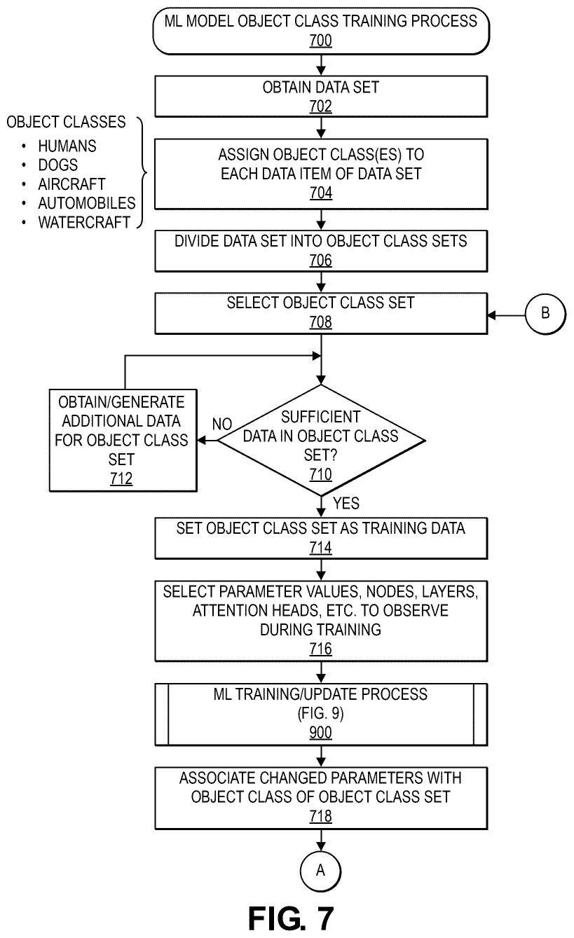

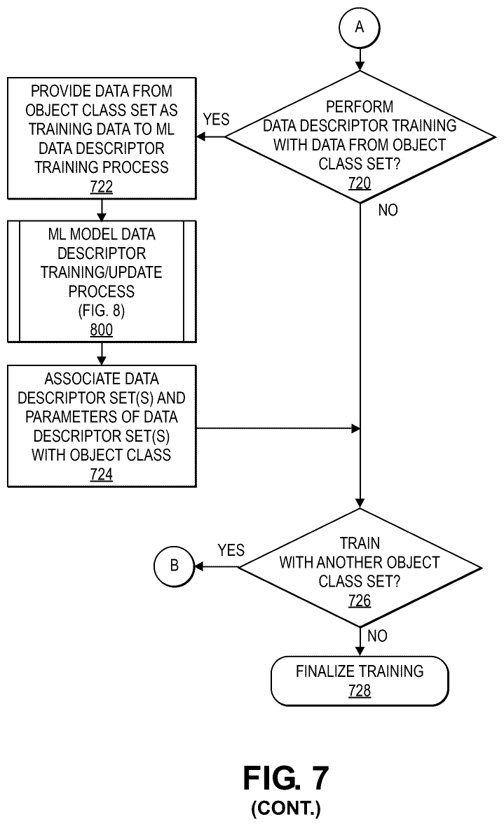

FIG. 7 is an example machine learning model object class training process 700, in accordance with disclosed implementations. The example process may be performed by the management system 120/160 discussed above. In other implementations, the example ML model object class training process 700 may be performed by an edge management system 160-A through 160-N operating at an edge location.

The example process 700 begins with the management system 120/160 obtaining or generating a data set, as in 702. The data set may be a predefined data set that is used for training, may be generated through observations or sensors that will generate data for the ML model once deployed, such as sensors at an edge location where an edge model will be deployed, etc. Likewise, the data set 702 may include any form of data for which the ML model is to be trained to determine objects of one or more object classes.

If not already assigned, the management system 120/160 assigns one or more object classes to each data item of the data set, as in 704. Object classes may be any class of objects. Example object classes include, but are not limited to, humans, dogs, aircraft, automobiles, watercraft, spacecraft, etc. In some examples, a data item may be assigned to one and only one object class. In other examples, a data item may be assigned to multiple object classes. For example, if the data item includes a representation of a human and a dog the data item may be assigned to both a human object class and a dog object class.

Once assigned, the management system 120/160 divides the data set into object class sets, as in 706. As noted above, if a data item is associated with or assigned to more than one object class, the data item may be included in multiple object class sets. If the data item is only associated with a single object class, the data item is included in the object class set for that object class.

The management system 120/160 may then select an object class set, as in 708, and determine if there is a sufficient quantity of data items in the object class set for training the ML model on the object class set, as in 710. In some examples, the management system 120/160 may require a minimum number of data items (e.g., 500, 1,000, 10,000) for training. In other examples, the management system 120/160 may determine the complexity of the object for which the ML model is to be trained and determine a minimum number of data items based on the complexity of the object. Less complex objects may require fewer data items for training while more complex objects may require a larger quantity of data items for training.

If the management system 120/160 determines that the selected object class set does not include a sufficient number of data items, the management system 120/160 obtains or generates additional data items for the object class set, as in 712. In some implementations, one or more sensors (e.g., cameras) may be used to collect additional data items that are associated with the object class. For example, if the object class is humans, a camera may be utilized to collect additional data items that include representations of humans. In addition, or as an alternative to collecting or obtaining additional data items, the management system 120/160 may generate additional data items for the data set through synthetic creation and/or by duplicating and altering aspects of existing data item of the object class set, thereby generating additional data items for the object class set. As the management system 120/160 generates or obtains additional data items for the object class set, the example process 700 returns to decision block 710 and continues.

At decision block 710, when the management system 120/160 determines that there is a sufficient number of data items in the object class set, the management system 120/160 sets the data items of the object class set as the training data that is to be used to train the ML model, as in 714. In addition, the management system 120/160 may select one or more parameter values, nodes, layers, attention heads, etc., to observe during training, as in 716. In some implementations, for example if the ML model is being trained by the management system 120 on a computing resource 121 that has a large amount of compute capacity and memory, all parameters of the ML model may be selected for observation. In other examples, if an edge management system 160-A through 160-N is training the ML model at an edge location with constrained compute capacity and/or memory, less than all of the parameters may be selected for observation. For example, if the ML model has been previously trained to detect objects of the object class, the parameters and nodes used by the ML model may be known and selected for training. In other implementations, a defined percentage of parameters may be selected for observation, for example randomly. In still other examples, structured pruning may be performed in which entire groups layers, nodes, attention heads, etc., are considered and optionally pruned together.

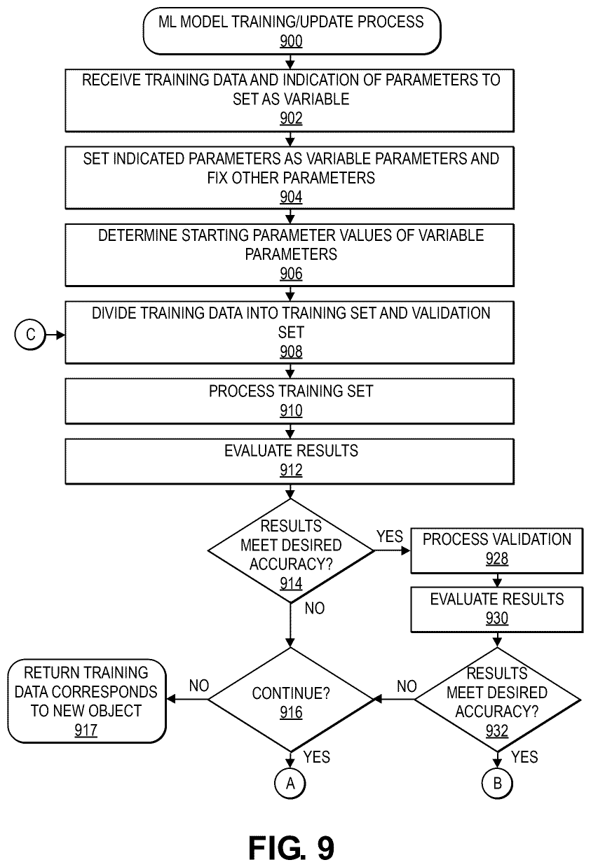

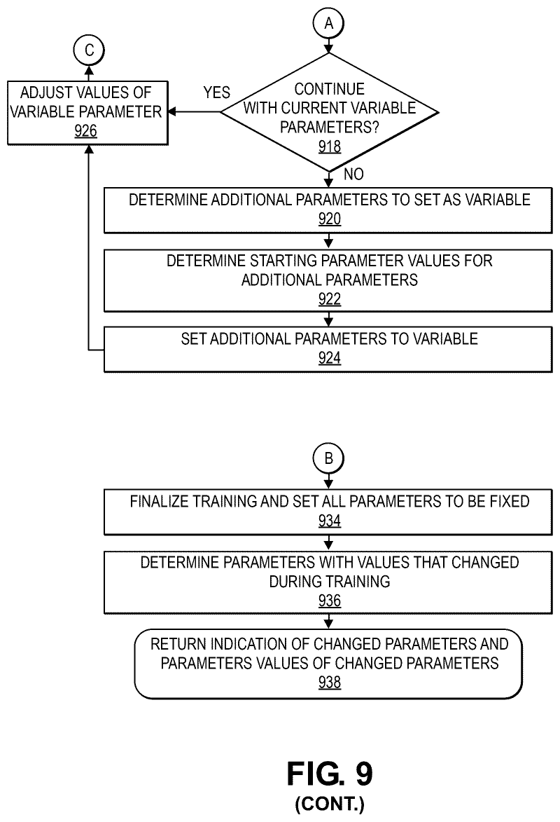

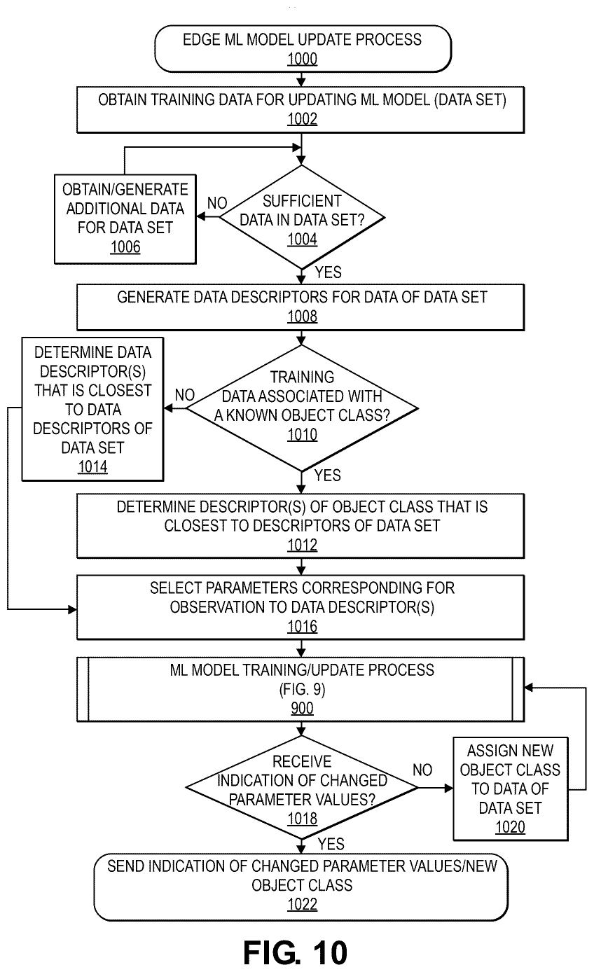

Utilizing the object class set and the selected parameters for observation, the ML training/update process 900 is performed. The example ML training/update process 900 is discussed further below with respect to FIG. 9. As discussed below, the example ML training/update process 900 returns an indication of changed parameters and parameter values of the changed parameters.

Upon completion of the example ML training/update process 900, the management system 120/160 associates the returned changed parameters with the object class of the selected object class set, as in 718. For example, if 1,000 nodes are selected for parameter observation, the example process may determine that only 600 of those nodes include parameters with changed parameter values observed during training of the ML model with data items corresponding to the object class. In such an example, only those 600 nodes are associated with the object class.

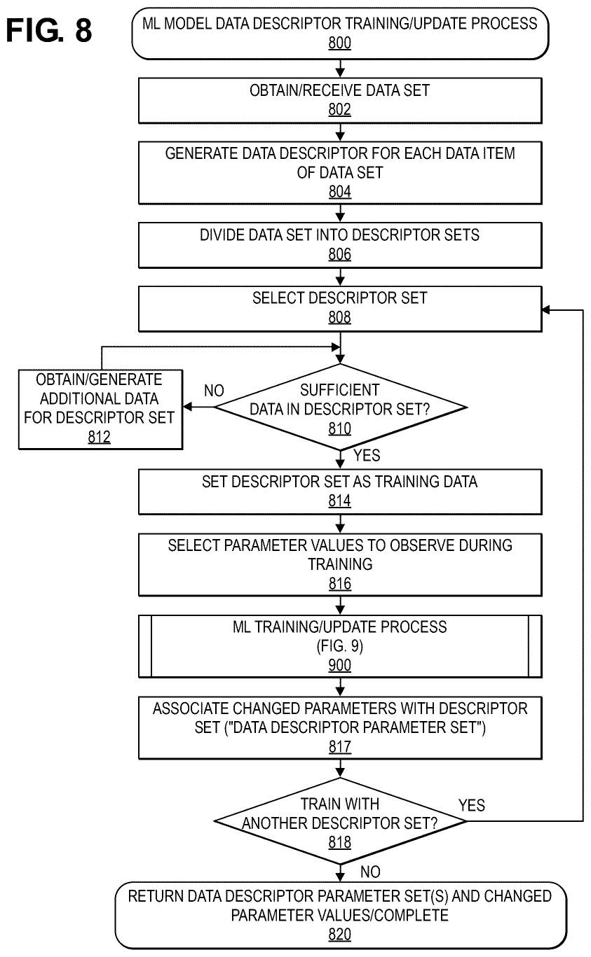

In some implementations, the management system 120/160 may also determine if the data items of the object class set are to be used to perform data descriptor training of the ML model, as in 720. If the management system 120/160 determines that the data items of the object class set are to be used for data descriptor training, the data items of the object class set are provided as training data to the ML data descriptor training process, as in 722, and the ML model data descriptor training/update process 800 is performed. An example ML model data descriptor training/update process 800 is discussed further below with respect to FIG. 8. As discussed below, the example ML model data descriptor training/update process 800 returns data descriptor parameter sets and changed parameter values of parameters of those data descriptor parameter sets.

Upon completion of the example ML model data descriptor training/update process 800, the management system 120/160 associates the data descriptor set(s) and parameters determined for the data descriptor set(s) with the object class, as in 724.

In addition to associating the data descriptor set(s) and parameters determined for the data descriptor set(s) with the object class, or if the management system 120/160 determines at decision block 720 that the data items of the object class set are not to be used to perform data descriptor training of the ML model, the management system 120/160 determines if training of the ML model with another object class set of the data set is to be performed as in 726. If the management system 120/160 determines that training of the ML model with another object class set of the data set is to be performed, the example process 700 returns to block 708 and continues. If the management system 120/160 determines that additional training of the ML model with another object class set of the data set is not to be performed, the training of the ML model is completed, as in 728.

FIG. 8 is an example machine learning model data descriptor training/update process 800, in accordance with disclosed implementations. The example process 800 may be performed by the management system 120 discussed above. In other implementations, the example ML model data descriptor training process 800 may be performed by an edge management system 160-A through 160-N operating at an edge location.

The example process 800 begins with the management system 120/160 obtaining, receiving, or generating a data set, as in 802. The data set may be a predefined data set that is used for training, may be generated through observations or sensors that will generate data for the ML model once deployed, such as sensors at an edge location where an edge model will be deployed, etc. In other examples, the data set may be an object class set received from the example process 700, discussed above with respect to FIG. 7. Like the data set discussed with respect to FIG. 7, the data set 802 may include any form of data for which the ML model is to be trained.

If not already assigned, the management system 120/160 generates and assigns one or more data descriptors to each data item of the data set, as in 804. As discussed above, a data descriptor is a machine-generated numerical representation that characterizes properties, attributes, and/or content of source data (data item). The data descriptor may be generated through one or more computational processes including, but not limited to, feature extraction techniques that identify and quantify specific attributes of the data item, embedding techniques that transform the data item into a compressed numerical representation within a continuous vector space, neural network processing that generates latent representations of the source data, dimensional reduction techniques applied to raw or processed data attributes, etc. A data descriptor may be structured as a one-dimensional vector, multi-dimensional tensor, or other numerical data structure suitable for computational processing. Elements of a data descriptor encode information about the data item so that the data descriptor may be used for similarity comparisons between different data items, classification or categorization of the data items, retrieval of related data items, reconstruction of properties of the original data item, etc. In implementations relating to image data, the data descriptor comprises a numerical representation that characterizes visual properties, semantic content, features, and/or other attributes of a source image, generated through computer vision techniques, neural network processing, or other computational methods.

Once assigned, the management system 120/160 divides the data set into data descriptor sets, as in 806. As noted above, if a data item is associated with or assigned to more than one data descriptor, the data item may be included in multiple data descriptor sets. If the data item is only associated with a single data descriptor, the data item is included in the data descriptor set for that data descriptor.

The management system 120/160 may then select a data descriptor set, as in 808, and determine if there is a sufficient quantity of data items in the data descriptor set for training the ML model on the data descriptor set, as in 810. In some examples, the management system 120/160 may require a minimum number of data items (e.g., 500, 1,000, 10,000) for training. In other examples, the management system 120/160 may determine the complexity of the object for which the ML model is to be trained and determine a minimum number of data items based on the complexity of the object. Less complex objects may require fewer data items for training while more complex objects may require a larger quantity of data items for training.

If the management system 120/160 determines that the selected data descriptor set does not include a sufficient number of data items, the management system 120/160 obtains or generates additional data items for the data descriptor set, as in 812. In some implementations, one or more sensors (e.g., cameras) may be used to collect additional data items that are processed to generate data descriptors corresponding to the data descriptor set. For example, if the data descriptor corresponds to humans wearing green pants, a camera may be utilized to collect additional data items that include representations of humans wearing green pants. In addition, or as an alternative to collecting or obtaining additional data items, the management system may generate additional data items for the data set through synthetic creation and/or by duplicating and altering aspects of existing data item of the data descriptor set, thereby generating additional data items for the data descriptor set. As the management system 120/160 generates or obtains additional data items for the data descriptor set, the example process 800 returns to decision block 810 and continues.

At decision block 810, when the management system 120/160 determines that there is a sufficient number of data items in the data descriptor set, the management system 120/160 sets the data items of the data descriptor set as the training data that is to be used to train the ML model, as in 814. In addition, the management system 120/160 may select one or more parameter values to observe during training, as in 816. In some implementations, for example if the ML model is being trained by the management system 120 on a computing resource 121 that has a large amount of compute capacity and memory, all parameters of the ML model may be selected for observation. In other examples, if an edge management system 160-A through 160-N is training the ML model at an edge location with constrained compute capacity and/or memory, less than all of the parameters may be selected for observation. For example, if the ML model has been previously trained to detect objects based on the data descriptor of the data descriptor set, the parameters and nodes used by the ML model may be known and selected for training. In other implementations, a defined percentage of parameters, nodes, layers, sections, attention heads, etc., may be selected for observation, for example randomly.

Utilizing the data descriptor set and the selected parameters for observation, the ML training/update process 900 is performed. The example ML training/update process 900 is discussed further below with respect to FIG. 9. As discussed below, the example ML training/update process 900 returns an indication of changed parameters and parameter values of changed parameters.

Upon completion of the example ML training/update process 900, the management system 120/160 associates the returned changed parameters with the data descriptor of the selected data descriptor set, as in 817. For example, if 1,000 nodes are selected for parameter observation, the example process may determine that only 600 of those nodes include parameters with changed parameter values observed during training of the ML model with data items corresponding to the data descriptor. In such an example, only those 600 nodes are associated with the data descriptor.

In addition to associating the changed parameters with the data descriptor, the management system 120/160 determines if training of the ML model with another data descriptor set of the data set is to be performed as in 818. If the management system 120/160 determines that training of the ML model with another data descriptor set of the data set is to be performed, the example process 800 returns to block 808 and continues. If the management system 120/160 determines that additional training of the ML model with another data descriptor set of the data set is not to be performed, data descriptor set(s) and changed parameter values are returned and the example process completes, as in 820.

FIG. 9 is an example machine learning model training/update process 900, in accordance with disclosed implementations. The example process 900 may be performed by the management system 120 discussed above. In other implementations, the example ML training/update process 900 may be performed by an edge management system 160-A through 160-N operating at an edge location.

The example process 900 begins by receiving training data and an indication of parameters to set as variable during training, as in 902. As discussed above with respect to FIGS. 7 and 8, parameters that are to be observed during training with selected training data may be determined by the example processes 700 or 800. For example, if the ML model is to be trained on data items of an object class set, the parameters known to change during training for that object class set may be indicated as the parameters to be observed. In such an example, the parameters to be observed are the parameters to be set to variable during training of the ML model in accordance with the example process 900. In other examples, if the ML model is being trained for the first time and/or trained on computing resources with excess compute and excess memory, all parameters of the ML model may be set to variable.

Upon receiving the indication of the parameters to set to variable, the management system 120/160 sets the indicated parameters as variable parameters and sets the other parameters of the ML model to fixed (frozen) so that those parameters do not change during training, as in 904. The management system also determines and stores the starting parameter values for each of the parameters that are set to variable, as in 906.

The management system 120/160 then divides the training data into training and validation sets, as in 908. Generally speaking, the data items in the training set are used to train the ML model and the data items in the validation set are used to validate the training of the ML model. As those skilled in the art will appreciate, and as described below in regard to much of the remainder of training process 900, there are numerous iterations or epochs of training and validation that occur during the training of the ML model.

At step 910 of the example training process 900, the management system 120/160 causes the ML model to process the data items of the training set, often in an iterative manner. Processing the data items of the training set includes capturing the processed results of the ML model to determine a difference or error between the input training data item and the result produced by the ML model. After processing the items of the training set through the ML model, at step 912, the management system 120/160 evaluates the results, and at step 914, determines whether a desired accuracy level has been achieved. If the desired accuracy level is not achieved, in step 916, the management system 120/160 determines if training is to continue. For example, the example process 900 may determine that training is only to be performed for a defined number of epochs before it is determined that training is not to continue. In another example, if training has been performed for multiple epochs and the error in the training is not improving, it may be determined that training is not to continue.

If the management system 120/160 determines that training is not to continue, the example process 900 returns an indication that the training data corresponds to a new or unknown object, as in 917. In some implementations, the example process 900 may provide additional information, such as the class that is most similar to the new or unknown object. As discussed further below with respect to FIG. 10, if a new or unknown object is potentially identified, it may be manually labeled or classified into a new object class (or an existing object class). In other examples, the new or unknown object may be automatically classified into a new object class, for example, based on the data descriptors of the object.

Returning to FIG. 9, if the management system 120/160 determines at block 916 that training is to continue, the management system 120/160 may further determine if the training is to continue with the same parameters that are set to variable or if additional parameters should be set to variable, as in 918. For example, if multiple epochs have been performed with a defined set of parameters set to variable and the results of training still do not meet the desired accuracy, the management system 120/160 may decide to add additional parameters as variable.

If the management system 120/160 determines that training is not to continue with just the current variables, the management system 120/160 determines additional parameters to set as variable during the training process 900, as in 920. For example, if the management system 120/160 is training the ML model with a data descriptor class that is associated with an object class, the management system 120/160 may decide to set some additional parameters of the object class that corresponds to the data descriptor to variable to see of those additional parameters will change during training and/or improve training of the ML model.

For the additional parameters that are set to variable, the management system 120/160 determines and stores the starting parameter values, as in 922, and sets those additional parameters to variable, as in 924. After setting the additional parameters to variable, or if it is determined at decision block 918 that training is to continue with the current parameters set to variable, at step 926, the values of the variables are adjusted in an effort to guide the ML model to generate more accurate results, and processing returns to step 908, where a new set of training data is selected, and the process repeats. Alternatively, if it is determined at decision block 914 that the desired accuracy level is achieved, the example ML model training/update process 900 advances to block 928.

At block 928, and much like block 910, the management system 120/160 causes the ML model to process data items of the validation set, and determines a difference or error between the input to the ML model and the resulting output. At block 930, the management system 120/160 evaluates the results of the processing of the validation set performed by the ML model. At block 932, the management system 120/160 determines whether a desired accuracy level, in processing the validation set, has been achieved. If the desired accuracy level is not achieved, the example process 900 returns to block 916 and continues. Alternatively, if the desired accuracy level is achieved, the training process 900 advances to block 934.

At block 934, the management system 120/160 finalizes training and sets all parameter values of the ML model to fixed. The management system 120/160 then observes, for example through an activation monitor, the parameter values of the parameters that were set to variable and determines, based on a difference between the parameters values stored before training and parameters values observed after training, which of the parameters set to variable have changed parameter values, as in 936.

Finally, the management system 120/160 returns and indication of the parameters with changed parameters values (“changed parameters”) and the new parameter values of those changed parameters, as in 938.

FIG. 10 is an example edge machine learning model update process 1000, in accordance with disclosed implementations. The example process 1000 may be performed by the management system 120 discussed above. In other implementations, the example edge model update process 1000 may be performed by an edge management system 160-A through 160-N operating at an edge location.

The example process 1000 begins with the management system 120/160 obtaining training data for use in updating the edge model, as in 1002. For example, if the edge model is operating on the edge computing apparatus at an edge location and a new object is identified, data items of the new object may be collected by sensors at the edge location. As another example, if the edge model is detecting an object class (e.g., employees at the edge location) but the quality/accuracy of detection is degrading (e.g., the season has changed and as a result the employees at the edge location are wearing different clothing) data items of that object class may be generated from sensors at the edge location.

The management system 120/160 determines if sufficient data items of the data set exist for training, as in 1004. In some examples, the management system 120/160 may require a minimum number of data items (e.g., 500, 1,000, 10,000) for training. In other examples, the management system 120/160 may determine the complexity of the object for which the ML model is to be trained and determine a minimum number of data items based on the complexity of the object. Less complex objects may require fewer data items for training while more complex objects may require a larger quantity of data items for training.

If the management system 120/160 determines that the data set does not include a sufficient number of data items, the management system 120/160 obtains or generates additional data items for the data set, as in 1006. In some implementations, one or more sensors (e.g., cameras) may be used to collect additional data items for the data set. For example, if the data set corresponds to humans wearing green pants, a camera may be utilized to collect additional data items that include representations of humans wearing green pants. In addition, or as an alternative to collecting or obtaining additional data items, the management system 120/160 may generate additional data items for the data set through synthetic creation and/or by duplicating and altering aspects of existing data item of the data descriptor set, thereby generating additional data items for the data set. As the management system 120/160 generates or obtains additional data items for the data descriptor set, the example process 1000 returns to decision block 1004 and continues.

At decision block 1004, when the management system 120/160 determines that there is a sufficient number of data items in the data set, the management system 120/160 generates one or more data descriptors for each data item of the data set, as in 1008. As discussed above, any of a variety of techniques may be used to generate data descriptors for data items of a data set.

The management system 120/160 then determines if the training data/data set is associated with a known object class, as in 1010. Continuing with the above example, if the training data is data items of employees wearing green pants and the object class is employees, all the collected/generated data items may be associated with the known object class of employees. In comparison, if the data items are images of an object that cannot be associated with a known object class, the data items may not be associated with a known object class.

If the management system 120/160 determines that the data items of the training data do not correspond to a known object class, the management system 120/160 determines existing data descriptors for which the ML model has been trained that are closest/most similar to the data descriptor(s) generated for the training data, as in 1014. If it is determined that the training data does correspond to a known object class, the management system 120/160 determines the data descriptor(s) associated with that object class that are closest/similar to the data descriptors of the training data, as in 1012. As discussed above distance/similarity between data descriptors may be determined based on the data descriptors in relation to other data descriptors. For example, if the data descriptors are embeddings or features of images, a distance between the embeddings or features in a dimensional space may be used to determine a similarity between data descriptors, with data descriptors that are closer together (clusters) having higher similarity compared to data descriptors that are farther apart.

After determining at blocks 1012 or 1014 known data descriptors that are closest/most similar to the data descriptors of the training data, the management system selects the parameters corresponding to the determined data descriptors for observation during training, as in 1016.

The management system 120/160 then performs the ML model training/update process 900 by providing the training data and parameters selected for observation to the example process 900. As discussed above, the example process 900 returns an indication of changed parameters determined during training with the example process 900 and the parameter values after training for those changed parameters.

Upon completion of the example ML model training/update process 900, the management system 120/160 determines if an indication of changed parameters was received, as in 1018. As discussed above, in some instances, the example ML model training process may determine to stop training and return an indication that the data item object class is unknown. If the management system 120/160 determines that it did not receive an indication of changed parameters, the management system 120/160 causes a new object class to be assigned to the training data, as in 1020. In some examples, the object class may be any unique identifier that is assigned to the training data. For example, the management system 120/160 may generate a random unique identifier (e.g., X7893ZY) that is assigned as the object class for the training data. In other examples, a human may review the training data and assign an object class that is more discernable to humans and/or determine that the training data should be included in a known class. For example, if the training data is an image of humans wearing an orange hard-hat and it is determined that the object (human wearing an orange hard-hat) corresponds to a new object class, when reviewed by a human it may be determined that the object is to be included in a class of objects of humans wearing hard-hats, regardless of color.

Upon selecting and assigning a new object class to the training data, the management system returns the training data, the parameters to observe, and the indication of the new object class for which the ML model is to be trained based on the ML model training/update process 900, and the example process 1000 continues. In some examples, the parameters selected for observation may be adjusted or increased beyond the original parameters selected for observation during training. Likewise, the example ML model training/update process may perform additional training beyond that discussed above to modify the ML model to produce an additional output corresponding to the new object class. For example, if the ML model is a multi-output model that is trained to produce a probability score indicating a probability of an input corresponding to each of a plurality of object classes (each represented as an output), the example process may update the model to include the new object class as an additional output.

Returning to decision block 1018, if the management system 120/160 determines that the ML model training/update process did return an indication of changed parameter values, an indication of the changed parameters and corresponding changed parameter values, and a new object class if generated, are sent by the management system, as in 1022. In some examples, the edge management system 160-A through 160-N operating at the edge location may send the changed parameter values to the management system 120 operating on the remote computing resources. As another example, the edge management system 160-A through 160-N operating at an edge location may send the changed parameter values to other edge management systems 160-A through 160-N operating at other edge locations and/or to the management system 120.

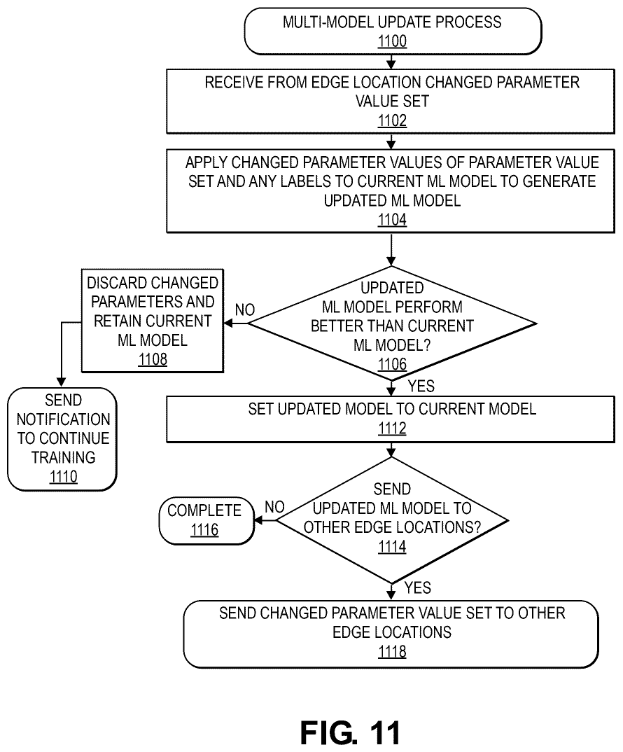

FIG. 11 is an example multi-model update process 1100, in accordance with disclosed implementations. The example process 1100 may be performed by the management system 120 operating on remote computing resources. In other implementations, the example process 1100 may be performed by a management system operating on an edge computing apparatus at an edge location.

The example process 1100 begins with the management system 120/160 receiving, from an edge location that is separate from the management system performing the example process 1100, a changed parameter value set that includes an indication of changed parameters of the ML model operating at an edge location, the changed parameter values for those changed parameters, and any new object class labels generated as part of updating the ML model, as in 1102. As discussed above with respect to FIG. 10, management systems 160-A through 160-N operating at edge locations may periodically, and independent of other management systems operating at the computing resources and/or operating at other edge locations, update the ML model at that edge location and send a changed parameter value set that includes an indication of the changed parameters, changed parameter values, and any labels generated as part of the ML model training to update the ML model at that location. By only sending the changed parameters, changed parameter values, and any created object class labels, there is no risk of security breach as no confidential, sensitive, or even usable information is being transmitted from the edge location. Additionally, while the changed parameters, changed parameter values, and any object class labels are referred to herein as a changed parameter value set, the changed parameters, changed parameter values, and/or new object class labels may be sent as separate transmissions between locations and need not be transmitted as a set.

Upon receipt of a changed parameter value set, the management system 120/160 applies the changed parameter values to the corresponding parameters of the ML model operating at the location with the management system to generate an updated ML model, as in 1104. If the management system 120 that received the changed parameter values set is operating at the remote computing resources 121, the management system 120 applies the changed parameter values to the ML model executing at the remote computing resources to generate an updated ML model at the remote computing resources. If the management system 160-A through 160-N that received the changed parameter value set is operating at another edge location 150-A through 150-N, the management system 160-A through 160-N applies the changed parameter values to the corresponding parameters of the edge model executing on the edge computing apparatus at that edge location to generate an updated ML model at the edge location.

Likewise, if new object class labels are received, as part of generating the updated ML model, the management system 120/160 adjusts the ML model to include the new object class labels as an additional output by the ML model.

The management system 120/160 then determines if the updated ML model performs better than the current model, as in 1106. Such determination may be with respect to overall performance of the ML model in general and/or determination as to whether the updated ML model performs better than the current ML model in identifying objects of the object class(es) associated with the changed parameters. As discussed above, parameters may be associated with one or more object classes as used by the ML model when processing inputs to determine whether the input includes the object class(es). Accordingly, in some examples, the management system 120/160 may utilize a data set of data items relevant to the object class(es) associated with the changed parameters and determine an accuracy of the current ML model at processing the data items of that data set. Likewise, the management system 120/160 may also utilize the data set to determine an accuracy of the updated ML model at processing the data items of that data set. If the accuracy of the updated ML model is higher than the accuracy of the current ML model, the management system 120/160 determines that the updated ML model performs better than the current ML model. If the accuracy of the updated ML model is equal to or lower than the accuracy of the current ML model, the management system 120/160 determines that the updated ML model performs worse than the current ML model.

If the management systems 120/160 determines that the updated ML model does not perform better than the current ML model (i.e., performs worse) the changed parameter values are discarded and the current ML model is maintained, as in 1108. Likewise, the management system 120/160 may also send a notification back to the management system 120/160 from which the changed parameter value set was received indicating that the management system should continue training those parameters, as in 1110.

If the management system 120/160 determines that the updated ML model performs better than the current ML model, the management system 120/160 defines the updated ML model as the current ML model, as in 1112, and determines if the updated ML model is to be sent to other edge locations, as in 1114. If the management system 120/160 determines that the updated ML model is not to be sent to other edge locations, the example process 1100 completes, as in 1116. If the management system 120/160 determines that the updated ML model is to be sent to other edge locations, the management system 120/160 sends the changed parameter value set to one or more other edge locations, as in 1118.

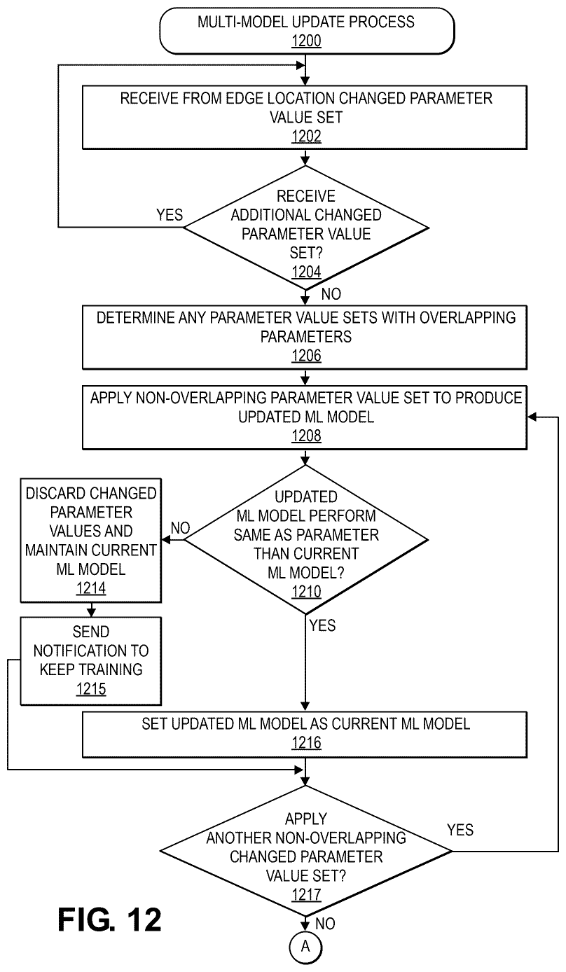

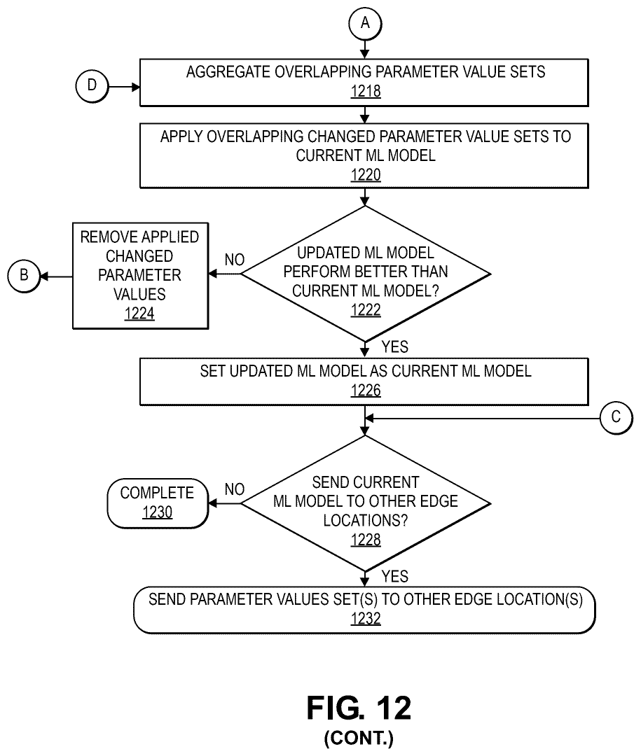

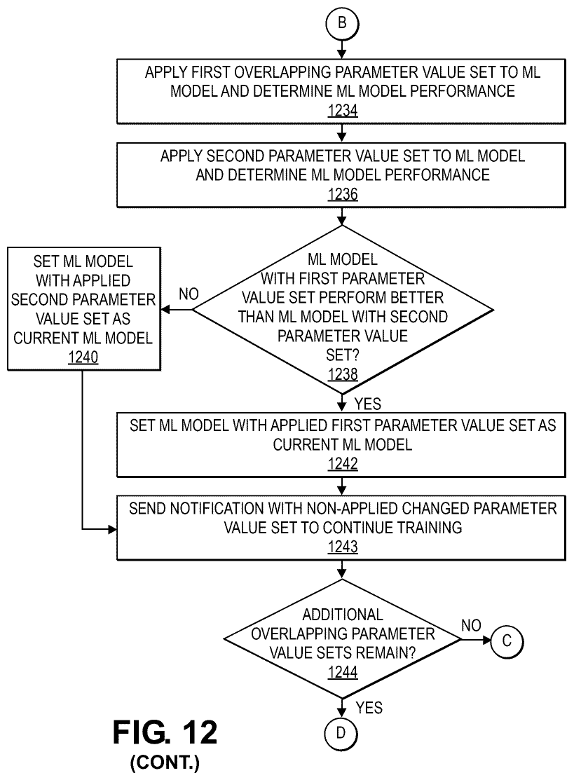

FIG. 12 is another example multi-model update process 1200, in accordance with disclosed implementations. In comparison to the example process 1100 discussed with respect to FIG. 11, in which changed parameter values are applied and considered when received, the example process 1200 discussed with respect to FIG. 12 includes combining, comparing, using, etc., changed parameter values received from multiple edge locations. The example process 1200 may be performed by the management system 120 operating on remote computing resources. In other implementations, the example process 1200 may be performed by a management system 160-A through 160-N operating on an edge computing apparatus at an edge location.

The example process 1200 begins with the management system 120/160 receiving, from an edge location that is separate from the management system 120/160 performing the example process 1200, a changed parameter value set that includes an indication of changed parameters of the ML model operating at the edge location, the changed parameter values for those changed parameters, and any new object class labels generated as part of updating the ML model, as in 1202. As discussed above with respect to FIG. 10, management systems 160-A through 160-N operating at edge locations may periodically, and independent of other management systems 120/160 operating at the computing resource and/or operating at other edge locations, update the ML model at that edge location and send a changed parameter value set that includes an indication of the changed parameters, changed parameter values, and any labels generated as part of the ML model training to update the ML model at that location. By only sending the changed parameters, changed parameter values, and any created object class labels, there is no risk of security breach as no confidential, sensitive, or even usable information is being transmitted from the edge location. Additionally, while the changed parameters, changed parameter values, and any object class labels are referred to herein as a changed parameter value set, the changed parameters, changed parameter values, and/or new object class labels may be sent as separate transmissions between locations and need not be transmitted as a set.

The management system 120/160 may then determine if one or more additional changed parameter value set are to be received from any other management system 120/160 operating at other edge locations, as in 1204. If the management system 120/160 determines that one or more additional changed parameter value sets are to be received, the example process 1200 returns to block 1202 and continues. In some implementations, a waiting period (e.g., 5 minutes, 1 hour, one day, etc.) may be utilized while the management system 120/160 performing the example process 1200 waits to see if any changed parameter value sets are received before continuing with the example process 1200.

If the management system 120/160 determines that no additional changed parameter value sets are to be received, the management system 120/160 determines any parameter value sets with overlapping changed parameters, as in 1206. As discussed above, different object classes may be determined and associated with one or more common parameters of the ML model. In such an example, if a first ML model returns a first changed parameter value set that is generated based on a training update for a first object class and a second ML model returns a second changed parameter value set that is generated based on a training update for a second object class, the management system may determine that one or more of the changed parameters of the two changed parameter value sets overlap. In another example, if two or more different management systems 120/160 return changed parameter value sets, both of which are generated based on training updates of the respective ML models for the same object class, some or all of the changed parameters may be the same in each changed parameter value set.

Returning to FIG. 12, after determining any changed parameter value sets with overlapping parameters, the management system 120/160 applies changed parameter values of a non-overlapping changed parameter value set to the corresponding parameters of the ML model operating at the location with the management system 120/160 to generate an updated ML model, as in 1208. If the management system 120/160 that received the changed parameter value set(s) is operating at the remote computing resources, the management system 120/160 applies the changed parameter values of a non-overlapping changed parameter value set to the ML model executing at the remote computing resources to generate an updated ML model at the remote computing resource. If the management system 120/160 that received the changed parameter value set(s) is operating at another edge location, the management system 120/160 applies the changed parameter values of the non-overlapping changed parameter value set to the corresponding parameters of the ML model executing on the edge computing apparatus at that edge location to generate an updated ML model at the edge computing apparatus.

Likewise, if new object class labels are received, as part of generating the updated ML model, the management system 120/160 adjusts the ML model to include the new object class labels as an additional output by the ML model.

The management system 120/160 then determines if the updated ML model performs better than the current model, as in 1210. Such determination may be with respect to overall performance of the updated ML model in general and/or determination as to whether the updated ML model performs better than the current ML model in identifying objects of the object class(es) associated with the changed parameters. As discussed above, parameters may be associated with one or more object classes as used by the ML model when processing inputs to determine whether the input includes the object class(es). Accordingly, in some examples, the management system 120/160 may utilize a data set of data items relevant to the object class(es) associated with the changed parameters and determine an accuracy of the current ML model at processing the data items of that data set. Likewise, the management system 120/160 may also utilize the data set to determine an accuracy of the updated ML model at processing the data items of that data set. If the accuracy of the updated ML model is higher than the accuracy of the current ML model, the management system 120/160 determines that the updated ML model performs better than the current ML model. If the accuracy of the updated ML model is equal to or lower than the accuracy of the current ML model, the management system 120/160 determines that the updated ML model performs worse than the current ML model.

If the management system 120/160 determines that the updated ML model does not perform better than the current ML model (i.e., performs worse) the changed parameter values of the applied non-overlapping changed parameter value set are discarded and the current ML model as maintained, as in 1214. Likewise, the management system 120/160 may also send a notification back to the management system(s) from which the changed parameter value set was received indicating that the management system 120/160 should continue training those parameters, as in 1215.

If the management system 120/160 determines that the updated ML model performs better than the current ML model with the changed parameter values of the non-overlapping changed parameter value set, the management system 120/160 defines the updated ML model as the current ML model, as in 1216. After defining the updated ML model as the current ML model (1216) or after discarding the changed parameter values and maintaining the current ML model (1214), the management system 120/160 determines if changed parameter values of another non-overlapping changed parameter value set are to be applied, as in 1217. If the management system 120/160 determines that changed parameter values of another non-overlapping changed parameter value set are to be applied and considered, the example process 1200 returns to block 1208 and continues.

If the management system 120/160 determines that changed parameter values of another non-overlapping changed parameter value set are not to be added to the ML model and considered, the management system 120/160 aggregates or combines changed parameter values of overlapping changed parameters of two or more received overlapping changed parameter value sets, as in 1218. Any of a variety of computations may be utilized to aggregate changed parameter values received in two or more changed parameter value sets that correspond to the same changed parameter. For example, a computation of the mean, median, Gaussian distribution, degrees of deviation, etc., may be used to aggregate the overlapping changed parameter values.

The management system 120/160 then applies the changed parameter values and the aggregated overlapping changed parameter values of the overlapping changed parameter value sets to the current ML model to generate and updated ML model, as in 1220, and determines if the updated ML model performs better than the current ML model, as in 1222. Determination of ML model performance at decision block 1222 may be the same as the determination of ML model performance discussed above with respect to decision block 1210.

If the management systems 120/160 determines that the updated ML model does not perform better than the current ML model (i.e., performs worse) the changed parameter values of the applied overlapping changed parameter value sets are removed, as in 1224. Additionally, the management system 120/160 may then apply the changed parameter values of the first overlapping changed parameter value set to the current ML model and determine a performance of the ML model with those applied changed parameter values, as in 1234. Likewise, the management system 120/160 may also apply the changed parameter values of a second overlapping changed parameter value set and determine the performance of the ML model with those changed parameter values, as in 1236. This may be done for each overlapping changed parameter value set that was aggregated by the management system 120/160 at block 1218. As such, if the management system 120/160 aggregated overlapping parameter values of more than two changed parameter value set, as part of the example process 1200 the management system 120/160 may determine the performance of the ML model with each of those changed parameter value sets independent of the other overlapping changed parameter value sets.

After determining the operation of the ML model with the overlapping changed parameter value sets applied independently, the management system 120/160 determines if the ML model performs better with the first changed parameter value set applied than it does with the second changed parameter value set applied, as in 1238. If there are more than two overlapping changed parameter value sets, the example process 1200 determines which overlapping changed parameter value set results in the best performance of the ML model. Likewise, the management system 120/160 may also confirm that each determined performance of the ML model with the different changed parameter value sets applied perform better than the current ML model and discard from consideration any that do not perform better than at least the current ML model.

If the management system 120/160 determines that the ML model performs better with the first changed parameter value set applied, the ML model with the changed parameter values of the first changed parameter values set applied is defined as the current ML model, as in 1242. If the management system 120/160 determines that the ML model performs better with the second changed parameter value set applied, the ML model with the changed parameter values of the second changed parameter value set applied is defined as the current ML model, as in 1240. If there are more than two overlapping changed parameter value sets, the management system determines which applied changed parameter value set results in the best performance of the ML model and defines that ML model as the current ML model.

For any overlapping changed parameter value set for which changed parameter values are not applied to generate the current ML model, the management system 120/160 may send a notification to the management system 120/160 from which the changed parameter value set is to be received, that the management system 120/160 is to continue training of those parameters, as in 1243. Additionally, the management systems 120/160 determines if additional overlapping parameter value sets remain for consideration, as in 1244. If the management system 120/160 determines that additional overlapping changed parameter value sets remain, the example process 1200 returns to block 1218 and continues. If the management system 120/160 determines that no additional overlapping changed parameter value sets remain, the example process 1200 proceeds to decision block 1228.

Returning to decision block 1222, if the management system 120/160 determines that the updated ML model with the overlapping changed parameter value sets applied performs better than the current ML model, the management system 120/160 defines the updated ML model as the current ML model, as in 1226. Additionally, the management system 120/160 determines if the updated ML model is to be sent to other edge locations, as in 1228. If the management system 120/160 determines that the updated ML model is not to be sent to other edge locations, the example process 1200 completes, as in 1230. If the management system 120/160 determines that the updated ML model is to be sent to other edge locations, the management system 120/160 sends the changed parameter value set(s) that were applied to generate the updated ML model to one or more other edge locations, as in 1232. In some implementations, if overlapping changed parameter value sets were applied to generate the updated ML model, the management system 120/160 may generate a new changed parameter value set based on the difference between the current ML model that existed before the example process 1200 began the current ML model generated through the example process 1200. In such an implementation, the new changed parameter value set will include an indication of the changed parameters that were changed as part of the example process 1200, the changed parameter values of those changed parameters, and any applied object class labels.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Persons having ordinary skill in the field of computers, communications, artificial intelligence, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein and/or that some steps or components discussed herein may be performed serially or in parallel. With respect to the one or more methods or processes of the present disclosure described herein, including but not limited to the flow chart shown in FIGS. 7 through 12, orders in which such methods or processes are presented are not intended to be construed as any limitation on the claimed inventions, and any number of the method or process steps or boxes described herein can be combined in any order and/or in parallel to implement the methods or processes described herein. Additionally, it should be appreciated that the detailed description is set forth with reference to the accompanying drawings, which are not drawn to scale.

Aspects of the disclosed systems may be implemented as a computer method or as an article of manufacture such as a memory device or non-transitory computer-readable storage medium. The computer-readable storage medium may be readable by a computer and may comprise instructions for causing a computer or other device to perform processes described in the present disclosure. The computer-readable storage media may be implemented by a volatile computer memory, non-volatile computer memory, hard drive, solid-state memory, flash drive, removable disk, virtual drive, and/or other media.

The data and/or computer-executable instructions, programs, firmware, software and the like (also referred to herein as “computer-executable” components) described herein may be stored on a computer-readable medium that is within or accessible by computers or computer components, or to any other computers or control systems, and having sequences of instructions which, when executed by one or more processors (e.g., CPU, GPU), cause the one or more processors to perform all or a portion of the functions, services, systems, and/or methods described herein. Such computer-executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some implementations of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, virtual drives, remote drives, or other types of media/machine-readable medium that may be suitable for storing electronic instructions. Further, implementations may also be provided as a computer-executable program product that includes a transitory machine-readable signal (in compressed or uncompressed form).

Most examples use at least one network that would be familiar to those skilled in the art for supporting communications using any of a variety of widely available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, satellite network, and any combination thereof.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

References to “one example,” “an example,” “one implementation,” “an implementation,” etc., indicate that the example or implementation described may include a particular feature, structure, or characteristic, but every example or implementation may not necessarily include the particular feature, structure, or characteristic. Moreover, such phrases are not necessarily referring to the same example or implementation. Further, when a particular feature, structure, or characteristic is described in connection with an example or implementation, it is submitted that it is within the knowledge of one skilled in the art to affect such feature, structure, or characteristic in connection with other examples or implementations whether or not explicitly described.

Moreover, in the various examples and implementations described above, unless specifically noted otherwise, use disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example or implementations requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A system, comprising:
a management system, operating on a computing environment, configured to at least:
generate, from a current machine learning (“ML”) model, a first edge model and a second edge model, the first edge model and the second edge model each including, at least, a first plurality of parameters having a first plurality of parameter values that are applied to input data as the input data is processed to produce output data;
send, to a first edge computing apparatus positioned at a first edge location that is separate from the computing environment, the first edge model; and
send, from the management system and to a second edge computing apparatus positioned at a second edge location that is separate from the first edge location, the second edge model;
the first edge computing apparatus configured to, at least:
process a first dataset of first data items generated at the first edge location to determine a first object class of a first object in at least two of the first data items;
determine a first sub-plurality of parameters of the first plurality of parameters corresponding to the first object class;
train the first edge model with the first dataset by, at least:
setting the first sub-plurality of parameters to variable so that a first sub-plurality of parameter values of the first plurality of parameter values can change as the model is trained;
setting a second sub-plurality of parameters of the first plurality of parameters to fixed so that a second sub-plurality of parameter values of the first plurality of parameter values does not change as the model is trained; and
provide the first data items to the first edge model as training inputs to train the first edge model;
observe the first sub-plurality of parameters to determine a second plurality of parameter values of the first sub-plurality of parameters that are changed as the first edge model is trained; and
send, to the management system, the second plurality of parameter values of the first sub-plurality of parameters; and
the management system further configured to, at least:
apply the second plurality of parameter values to the first sub-plurality of parameters of the current ML model to produce an updated ML model; and
send, to the second edge computing apparatus, the second plurality of parameter values so that the second edge computing apparatus can apply the second plurality of parameter values as parameter values for the first sub-plurality of parameters of the second edge model.

2. The system of claim 1, wherein:
the management system is further configured to, at least:
subsequent to applying the second plurality of parameter values to the first sub-plurality of parameters of the ML model to produce the updated ML model, determine that the updated ML model performs better than the current ML model; and
the second plurality of parameter values is sent to the second edge computing apparatus in response to the determination that the updated ML model performs better than the current ML model.

3. The system of claim 1, wherein the management system is further configured to, at least:
process, with the current ML model, a second dataset of second data items that include objects of the first object class to determine the first sub-plurality of parameters of the first plurality of parameters; and
send, to the first edge computing apparatus, an indication of the first sub-plurality of parameters, and
wherein the first edge computing apparatus determines the first sub-plurality of parameters from the indication sent by the management system.

4. The system of claim 1, wherein the second edge computing apparatus is further configured to, at least:
receive, from the management system, an indication of a third sub-plurality of parameters of the first plurality of parameters corresponding to a second object class;
process a second dataset of second data items generated at the second edge location to determine that at least two of the second data items include objects of the second object class;
train the second edge model with the second dataset by, at least:
setting the third sub-plurality of parameters to variable so that a third sub-plurality of parameter values of the first plurality of parameter values can change as the model is trained;
setting a fourth sub-plurality of parameters of the first plurality of parameters to fixed so that a fourth sub-plurality of parameter values of the first plurality of parameter values does not change as the model is trained; and
provide one or more of the second data items to the first edge model as training inputs to train the second edge model;
observe the third sub-plurality of parameters to determine a fourth sub-plurality of parameter values of the third sub-plurality of parameters that are changed as the second edge model is trained; and
send, to the management system, the fourth sub-plurality parameter values of the third sub-plurality of parameters.

5. The system of claim 4, wherein:
a first parameter of first plurality of parameters is included in the first sub-plurality of parameters and the third sub-plurality of parameters; and
wherein the management system is further configured to, at least:
combine a first parameter value of the first parameter received from the first edge computing apparatus with a second parameter value of the first parameter received from the second computing apparatus before the first sub-plurality of parameters and the third sub-plurality of parameters are applied to the current ML model to produce the updated ML model;
select the first parameter value as the parameter value for the first parameter that is applied to the current ML model; or
select the second parameter value as the parameter value for the first parameter that applied to the current ML model.

6. A computer-implemented method, comprising:
receiving, from a first edge computing apparatus, a first sub-plurality of parameter values of a first sub-plurality of parameters of a first plurality of parameters of a first machine learning (“ML”) model executing at the first edge computing apparatus;
generating, from a second ML model, an updated ML model by applying the first sub-plurality of parameter values to a second sub-plurality of parameters of a second plurality of parameters of the second ML model, wherein the second sub-plurality of parameters correspond to the first sub-plurality of parameters; and
sending, to a second edge computing apparatus, the first sub-plurality of parameter values so that the second edge computing device applies the first sub-plurality of parameter values to a third ML model executing at the second edge computing apparatus.

7. The computer-implemented method of claim 6, further comprising:
providing, as part of a training of the second ML model, a plurality of training data items that include an object of an object class;
observing, as a result of the training of the second ML model:
a change in the first sub-plurality of parameter values of the first sub-plurality of parameters; and
an absence of change in a third sub-plurality of parameter values of a third sub-plurality of parameters of the first plurality of parameters;
determining, based at least in part on the change in the first sub-plurality of parameter values and the absence of change in the third sub-plurality of parameter values, that the first sub-plurality of parameters are used by the second ML model to determine an identity of objects of the object class; and
sending, to the first ML model an indication that when training the first ML model to detect objects of the object class:
to set the first sub-plurality of parameters to variable so that the first sub-plurality of parameter values can change as the model is trained; and
to set the third sub-plurality of parameters to fixed so that the third sub-plurality of values do not change as the model is trained.

8. The computer-implemented method of claim 6, further comprising:
providing, as part of a training of the second ML model, a plurality of training data items that have a substantially similar object descriptor;
observing, as a result of the training of the second ML model:
a change in the first sub-plurality of parameter values of the first sub-plurality of parameters; and
an absence of change in a third sub-plurality of parameter values of a third sub-plurality of parameters of the first plurality of parameters;
determining, based at least in part on the change in the first sub-plurality of parameter values and the absence of change in the third sub-plurality of parameter values, that the first sub-plurality of parameters are used by the second ML model to determine an identity objects of an object class represented in data items of the plurality of training data items; and
sending, to the first ML model, an indication that when training the first ML model to detect objects of the object class:
to set the first sub-plurality of parameters to variable so that the first sub-plurality of parameter values can change as the model is trained; and
to set the third sub-plurality of parameters to fixed so that the third sub-plurality of values do not change as the model is trained.

9. The computer-implemented method of claim 6, further comprising:
receiving, from a third edge computing apparatus, a third sub-plurality of parameter values of the first plurality of parameter values; and
wherein generating the updated ML model further includes:
generating, from the second ML model, the updated ML model by, at least:
applying the first sub-plurality of parameter values to the second sub-plurality of parameters of the second plurality of parameters of the second ML model, wherein the second sub-plurality of parameters correspond to the first sub-plurality of parameters; and
applying the third sub-plurality of parameter values to a fourth sub-plurality of parameters of the second plurality of parameters of the second ML model, wherein the fourth sub-plurality of parameters correspond to the third sub-plurality of parameters.

10. The computer-implemented method of claim 6, further comprising:
receiving, from a third edge computing apparatus, a third sub-plurality of parameter values of the first plurality of parameter values; and
determining, that a first parameter of the first sub-plurality of parameter values and a second parameter of the third sub-plurality of parameter values both correspond to a third parameter of the second sub-plurality of parameter values; and
wherein generating the updated ML model further includes:
generating, from the second ML model, the updated ML model by, at least:
combining a first parameter value of the first parameter and a third parameter value of the third parameter to generate a second parameter value;
applying the second parameter value to a second parameter of the second plurality of parameters;
applying a first remainder of the first sub-plurality of parameter values to the second sub-plurality of parameters; and
applying a second remainder of the third sub-plurality of parameter values to a fourth sub-plurality of parameters of the second plurality of parameters.

11. The computer-implemented method of claim 6, further comprising:
receiving, from a third edge computing apparatus, a third sub-plurality of parameter values of the first plurality of parameter values;
determining, that at a first parameter of the first sub-plurality of parameter values and a second parameter of the third sub-plurality of parameter values both correspond to a third parameter of the second sub-plurality of parameter values;
determining that the second ML model performs better with a first parameter value of the first parameter applied to a second parameter of the second plurality of parameters of the second ML model; and
wherein generating the updated ML model further includes:
generating, from the second ML model, the updated ML model by, at least, applying the first sub-plurality of parameter values to the second sub-plurality of parameters, including applying the first parameter value to the second parameter.

12. The computer-implemented method of claim 6, further comprising:
receiving, from a third edge computing apparatus executing a third ML model, a third sub-plurality of parameter values of the first plurality of parameter values;
generating, from the updated ML model, a third ML model by applying the third sub-plurality of parameter values to a fourth sub-plurality of parameters of a fourth plurality of parameters of the updated ML model, wherein the fourth sub-plurality of parameters correspond to the third sub-plurality of parameters;
determining that the third ML model performs worse than the updated ML model;
discarding the third ML model; and
sending, to the third edge computing apparatus, an indication for the third edge computing apparatus to continue training the third ML model.

13. The computer-implemented method of claim 6, wherein the second ML model is executing on a third edge computing apparatus that is periodically communicatively connected to at least one of the first edge computing apparatus of the second edge computing apparatus.

14. The computer-implemented method of claim 6, wherein the second ML model is executing on a management system operating on a remote computing resource that is periodically communicatively connected to at least one of the first edge computing apparatus of the second edge computing apparatus.

15. A computer-implemented method, comprising:
receiving at an edge location executing a first machine learning (“ML”) model, an indication of:
a first sub-plurality of parameters of a first plurality of parameters of the first ML model to set to variable during training of the first ML model so that a first sub-plurality of parameter values of the first sub-plurality of parameters can change as the first ML model is trained to identify a first object class of objects; and
a second sub-plurality of parameters of the first sub-plurality of parameters of the first ML model to set to fixed during training of the first ML model so that a second sub-plurality of parameter values of the second sub-plurality of parameters remain unchanged as the first ML model is trained to identify the first object class of objects;
generating an updated ML model by training the first ML model to identify the first object class of objects by, at least:
setting the first sub-plurality of parameters to variable so that the first sub-plurality of parameter values of the first plurality of parameters change as the first ML model is trained;
setting the second sub-plurality of parameters to fixed so that the second sub-plurality of parameter values of the second sub-plurality of parameters remain unchanged as the first ML model is trained;
providing, as inputs to the first ML model, training data; and
completing the training of the first ML model to produce the updated ML model; and
subsequent to completing the training to produce the updated ML model:
determining that the updated ML model performs better than the first ML model at identifying objects of the first object class;
observing the first sub-plurality of parameters of the updated ML model to determine the first sub-plurality of parameter values changed during the training; and
sending, the first sub-plurality of parameter values changed during the training without sending the second sub-plurality of parameter values.

16. The computer-implemented method of claim 15, further comprising:
receiving, subsequent to sending the first sub-plurality of parameter values changed during the training, an indication to continue training the first sub-plurality of parameters; and
in response to receiving the indication:
generating a second updated ML model by training the updated ML model to identify the first object class of objects by, at least:
setting the first sub-plurality of parameters of the updated ML model to variable so that the first sub-plurality of parameter values of the first sub-plurality of parameters change as the updated ML model is trained;
setting the second sub-plurality of parameters of the updated ML model to fixed so that the second sub-plurality of parameter values of the second sub-plurality of parameters remain unchanged as the updated ML model is trained;
providing, as inputs to the updated ML model, second training data; and
completing the training of the updated ML model to produce the second updated ML model;
subsequent to completing the training to produce the second updated ML model:
determining that the second updated ML model performs better than the updated ML model at identifying objects of the first object class;
observing the first sub-plurality of parameters of the second updated ML model to determine the first sub-plurality of parameter values changed during the training to produce the second updated ML model; and
sending, the first sub-plurality of parameter values changed during the training to produce the second updated ML without sending the second sub-plurality of parameter values.

17. The computer-implemented method of claim 15, further comprising:
receiving, at the edge location, a third sub-plurality of parameter values corresponding to a third sub-plurality of parameters of the first sub-plurality of parameters;
applying the third sub-plurality of parameter values to the third sub-plurality of parameters of the updated ML model to produce a second updated ML model; and
using the second updated ML model to process input data and determine objects of a second object class that is different than the first object class.

18. The computer-implemented method of claim 17, further comprising:
confirming that an operation of the second updated ML model is an improvement over the updated ML model.

19. The computer-implemented method of claim 15, further comprising:
determining a data descriptor for each data item of the training data;
determining that the data descriptor corresponds to the first object class; and
setting the first sub-plurality of parameters to variable and the second sub-plurality of parameters to fixed in response to determining that the data descriptor corresponds to the first object class.

20. The computer-implemented method of claim 15, further comprising:
determining a data descriptor for each data item of a second training data;
in response to determining the data descriptor;
setting a third sub-plurality of parameters of the updated ML model to variable, wherein the third sub-plurality of parameters are associated with at least one of the data descriptor or a second object class that includes the data descriptor; and
setting a fourth sub-plurality of parameters of the updated ML model to fixed;
producing a second updated ML model through a second training of the updated ML model by providing the second training data to the updated ML model;
subsequent to the second training of the updated ML model to produce the second updated ML model, observing the third sub-plurality of parameter values of the second ML model that changed during the second training; and
sending the third sub-plurality of parameter values without sending the fourth sub-plurality of parameter values.
